(19) United States
(12) Patent Application Publication
(10) Pub. No.: US 2025/0182510 A1
(43) Pub. Date: Jun. 5, 2025

(54) System and Methods for Multi-Modal Data Authentication Using Neuro-Symbolic AI

(71) Applicant: PROBETRUTH, INC., Ann Arbor, MI (US)

(72) Inventors: Khalid Mahmood Malik, Rochester Hills, MI (US); Ijaz ul Haq, Grand Blanc, MI (US)

(73) Assignee: PROBETRUTH, INC., Ann Arbor, MI (US)

(21) Appl. No.: 19/050,072

(22) Filed: Feb. 10, 2025

Related U.S. Application Data
(63) Continuation-in-part of application No. 18/959,572, filed on Nov. 25, 2024.
Application No. 18/959,572 is a continuation-in-part of application No. 18/629,904, filed on Apr. 8, 2024, now abandoned.
(60) Provisional application No. 63/495,094, filed on Apr. 8, 2023.

(51) Int. Cl. G06V 20/00; G06V 10/764; G06V 10/77; G06V 10/82; G06V 40/16; G10L 15/16

(52) U.S. Cl. CPC G06V 20/95; G06V 10/764; G06V 10/7715; G06V 10/82; G06V 40/176; G10L 15/16

(57) ABSTRACT

A method for generating a multimodal forensic report using hybrid metric learning and signature-based models is disclosed herein. The method involves receiving and preprocessing sensory data, extracting features using AI models, applying reasoning for anomaly detection and classification, and integrating spatiotemporal, multimodal AI representation learning, and symbolic knowledge. Dynamic domain-specific knowledge is generated by applying data-driven and ontology knowledge to the model. Explanations are generated using unimodal and multimodal reasoning, and associated features are sorted, prioritized, and indexed in a structured format.

### CROSS-REFERENCE TO RELATED APPLICATIONS

This application is a continuation-in-part of U.S. patent application Ser. No. 18/959,572, filed on Nov. 25, 2024, which is a continuation-in-part of U.S. patent application Ser. No. 18/629,904, filed on Apr. 8, 2024, which claims the benefit of U.S. Provisional Patent Application Ser. No. 63/495,094, filed on Apr. 8, 2023, the entireties of which are hereby incorporated herein by reference.

### BACKGROUND

### Field of the Invention

The present disclosure relates to the field of authenticity verification and, in particular, relates to systems and methods for authenticity verification of audio and video data. More particularly, the disclosure relates to an exemplary method and system which utilizes Neuro-Symbolic Artificial Intelligence to authenticate unimodal and multimodal sensory data to discern whether given media is partially or fully AI generated (deepfake) or real.

### Description of the Related Art

Conventionally, in addition to authenticity, the integrity of admitted evidence is paramount, necessitating the detection of discontinuities in recordings and specific attacks, such as insertion and deletion. Moreover, forensic models used to detect forgeries must be fair and offer explainability to ensure unbiased decisions.

However, existing forensic examiners often lack these essential characteristics, limiting their ability to satisfy the requirements of criminal justice and social media platforms. Traditional methods of multimedia forensic analysis, such as manual preparation of multimodal forensic reports, are time-consuming, expensive, less reliable, and require highly specialized skills. Judges also face difficulties in making decisions due to conflicting expert opinions.

### SUMMARY

The present disclosure describes a method of generating a multimodal forensic report, comprising hybrid metric learning and signature-based model by receiving data from one or more sources of sensory data, where the sensory data comprises multimodal or single-modality sensory data. The method may further comprise preprocessing the sensory data comprising applying normalization to the data, extracting features utilizing artificial intelligence models where the features comprise spatial, temporal, spatiotemporal, spectral, handcrafted, and biometric features, applying unimodal or multimodal reasoning on the extracted features, detecting anomalies based on an interfeature or intrafeature reasoning, applying binary or multiclass classification based on an interfeature or intrafeature reasoning, integrating spatiotemporal, temporal, and spatial features, multimodal AI representation learning features, and symbolic knowledge derived from landmark features and the interfeature and the intrafeature reasoning, and integrating the detected anomalies and the binary or multiclass classification. The multiclass classification may include sub types of the forgeries such as faceswap, face-enhancement, attribute manipulation, lipsync, expression swap, neural texture, talking face generation, replay attack, voice cloning attack, or any combination of these forgeries (i.e., replay and cloning). In an exemplary embodiment, the method may further include generating dynamic domain specific knowledge by applying data driven knowledge and ontology knowledge to the hybrid metric learning and signature-based model, by extracting data driven knowledge from the hybrid metric learning and signature-based model by applying artificial intelligence models, where the data driven knowledge comprises biological cues including emotions and temperature, storing human knowledge, in one or more databases, where the human knowledge comprises rules, information, ranges, or ontology obtained from human domain experts, generating explanations based on the dynamic domain specific knowledge and the authentication data by applying unimodal and multimodal reasoning on the dynamic domain specific knowledge and the authentication data, and sorting, prioritizing, and indexing associated features in a structure which includes annotated rules, visual data, and statistic data.

Exemplary embodiments allow for utilizing a Deep Forgery Detector (DFD) that performs deep inspection at the file and frame levels. Specifically, DFD aims to answer critical questions related to the authenticity and integrity of unimodal and multimodal sensor data. These questions include identifying visual forgeries, detecting manipulated audio or video data, verifying the recording device, linking a recording to the device used, ensuring the consistency of recording content with the claimed device and location, and identifying the algorithm used to create synthetic data.

DFD represents a significant advancement in multimedia and sensor forensics, offering a reliable method for distinguishing genuine data from altered or AI synthetic data. It also detects and localizes the partial deepfake audios and videos. It automates the forensic analysis process and generates reliable forensic reports, addressing the pressing need for sophisticated mechanisms to verify the accuracy and reliability of sensory data used as evidence in legal proceedings.

### BRIEF DESCRIPTION OF THE DRAWINGS

The novel features disclosed herein with respect to structure, organization, use, and method of operation, together with further objectives and advantages thereof, will be better understood from the following drawings in which a presently preferred embodiment of the present disclosure will now be illustrated by way of example. It is expressly understood, however, that the drawings are for the purpose of illustration and description only and are not intended as a definition of the limits of the present disclosure. Embodiments will now be described by way of example in association with the accompanying drawings in which:

FIG. 1 illustrates a block diagram of a Deep Forgery Detection System, consistent with one or more exemplary embodiments of the present disclosure;

FIG. 2 illustrates a block diagram of an exemplary processing system for sensor data and forgery detection, consistent with one or more exemplary embodiments of the present disclosure;

FIG. 3A illustrates a block diagram of an exemplary training process for Multimodal Deepfake Knowledge Graph (MDKG) generation using models' integration, consistent with one or more exemplary embodiments of the present disclosure;

FIG. 3B illustrates a block diagram of an exemplary inferencing processing of rules generation, consistent with one or more exemplary embodiments of the present disclosure;

FIG. 3C is an extended diagram of PMI (Prioritization Model Indices) describing the working flow or mechanisms, consistent with one or more exemplary embodiments of the present disclosure;

FIG. 3D is extended diagram of a Signature Amplification unit, consistent with one or more exemplary embodiments of the present disclosure;

FIG. 3E is an example of facial vocabulary generation for rules extraction with grouped landmarks for each facial part and corresponding derived vocabulary for each facial part (same color code), consistent with one or more exemplary embodiments of the present disclosure;

FIG. 3F is an example of performant data-driven rules and their support score, consistent with one or more exemplary embodiments of the present disclosure;

FIG. 3G is an example of ontology/schema of deepfake detection/forensic models that uses biological signals, aural artifacts, multimodal artifacts, visual artifacts, and other physics informed about real and manipulated media, consistent with one or more exemplary embodiments of the present disclosure;

FIG. 4A illustrates various components of the Interpretability analysis unit, consistent with one or more exemplary embodiments of the present disclosure;

FIG. 4B shows an example of the developed Multimodal Deepfake Knowledge Graph (MDKG) for unimodal and multimodal reasoning generated based on ontology of deepfake forensic models, consistent with or more exemplary embodiments of the present disclosure;

FIG. 5 illustrates a unimodal forgery detection model, consistent with one or more exemplary embodiments of the present disclosure;

FIG. 6A illustrates a temporal process similar to any of the exemplary temporal processes for inter- and intra-modality reasoning based on domain knowledge, consistent with one or more exemplary embodiments of the present disclosure;

FIG. 6B illustrates an example of psychological knowledge (emotion) with a table of probabilities where emotions are changing from one state to another and a quadrant of emotional distribution, consistent with one or more exemplary embodiments of the present disclosure;

FIG. 6C illustrates visual graphs highlighting inconsistency detection for intermodality and intramodality, consistent with one or more exemplary embodiments of the present disclosure;

FIG. 7A illustrates an exemplary lip synchronization approach, consistent with one or more exemplary embodiments of the present disclosure;

FIG. 7B illustrates an example of how the movement of lips in the sequence of frames varies in case of real, faceswap, and lipsync media, consistent with one or more exemplary embodiments of the present disclosure;

FIG. 7C is a scatter plot illustrating the correlation between audio and video representations, consistent with one or more exemplary embodiments of the present disclosure;

FIG. 8A depicts a block diagram of a generalized deepfake detection model based on a DBaG descriptor, consistent with one or more exemplary embodiments of the present disclosure;

FIG. 8B illustrates an exemplary scenario providing insight into functionality of a DBaG descriptor, consistent with one or more exemplary embodiments of the present disclosure;

FIG. 9 illustrates various components of an exemplary report generation unit, consistent with one or more exemplary embodiments of the present disclosure; and

FIG. 10 illustrates an example computer system 1600 in which an embodiment, or portions thereof, may be implemented as computer-readable code, consistent with exemplary embodiments of the present disclosure.

### DETAILED DESCRIPTION

The novel features with respect to structure, organization, use, and method of operation, together with further objectives and advantages thereof, will be better understood from the following detailed description.

It will be understood that some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In some embodiments, the various components may reflect the use of corresponding components in an actual implementation. In other embodiments, any single component illustrated in the figures may be implemented by a number of actual components. The depiction of any two or more separate components in the figures may reflect different functions performed by a single actual component. The figures discussed below provide details regarding exemplary systems that may be used to implement the disclosed functions.

Some concepts are described in the form of steps of a process or method. In this form, certain operations are described as being performed in a certain order. Such implementations are exemplary and non-limiting. Certain operations described herein can be grouped together and performed in a single operation, certain operations can be broken apart into plural component operations, and certain operations can be performed in an order that differs from that which is described herein, including a parallel manner of performing the operations. The operations can be implemented by software, hardware, firmware, manual processing, and the like, or any combination of these implementations. As used herein, hardware may include computer systems, discrete logic components, such as application specific integrated circuits (ASICs) and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

As utilized herein, terms “component,” “system,” “client,” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device or media.

Non-transitory computer-readable storage media can include but are not limited to magnetic storage devices (e.g., hard disk, floppy disk, and magnetic strips, among others), optical discs (e.g., compact disc (CD), and digital versatile disc (DVD), among others), smart cards, and flash memory devices (e.g., card, stick, and key drive, among others). By contrast, computer-readable media generally (i.e., not necessarily storage media) may additionally include communication media such as transmission media for wireless signals and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Exemplary embodiments provide a unified tool, an exemplary Deep Forgery Detector (DFD), which may aid in detecting various sensor forgeries, such as audio-visio forgeries. In some exemplary embodiments, audio-visio forgeries may include various types of deepfakes, that may be used in the manipulation and/or falsification of digital multimedia and other sensors (such as cameras on cars). In an exemplary embodiment, exemplary DFD may generate unimodal and multimodal sensors (e.g., video) forensic reports using neuro-symbolic techniques. In an exemplary embodiment, in using neuro-symbolic AI methods, DFD may include a single and multimodal data authenticity analysis unit which may aid in identifying any tampering, manipulation, or other alterations such as fully or partially AI generated contents in the given sensory input (e.g., shallow and deepfakes). In some exemplary embodiments, in an exemplary scenario where integrity verification is conducted with respect to data associated with autonomous vehicles, exemplary data may be received or be a combination of lidar, radar, and vision sensor data.

Due to its neuro-symbolic nature, a single and multimodal data authenticity analysis unit uses a combination of deep learning, machine learning classification, and symbolic reasoning techniques to detect forgery in the sensory input. Additionally, the hybrid nature of metric learning (used for multiclass anomaly detection in unit 09 and signature-based approach/classification (unit 10) helps an exemplary system in detecting both known/seen and unknown/unseen forgeries. In some exemplary embodiments, an exemplary system detects anomalies in each modality (i.e., aural or video) if input is multimodal data. In some exemplary embodiments, modality may refer to audio or video data. In some exemplary embodiments, an exemplary signature-based classification approach uses joint representation, as well as spatial and temporal feature representation. In some exemplary embodiments, utilizing intermodality and intramodality approaches allows for further improvement and generalizability of forgery detection. In some exemplary embodiments, meta learning involves training a model to learn a similarity metric between real/positive class samples, ensuring that similar genuine samples are closer in the learned embedding space. Meanwhile, negative classes in metric learning, representing spoofed samples, are learned to be distinct from genuine ones. This approach enables the model to effectively distinguish between real and spoofed voices based on their learned representations. Unlike traditional anomaly detection methods, which rely only on detecting deviations from real samples, metric learning focuses on explicitly learning the relationships between data points, thereby enhancing its capability to discern subtle differences in complex data distributions. In some exemplary embodiments, in parallel, binary or multi-class classification is performed within a supervised and semi-supervised learning framework to learn the behavioral signatures of identities/forgeries/generative AI-algorithms, utilizing semantically learned deep representations of both unimodal and multimodal data. Overall, the integrated meta-learning and signature based enables the DFD to not only distinguish between genuine and spoofed samples but also capture intricate identity-specific features for robust data authenticity.

In an exemplary embodiment, an exemplary system may also include an exemplary personalized multimodal report generation unit that may also use a neuro-symbolic approach to generate a multimodal forensic report based on the findings of an exemplary explainable authenticity analysis unit. In some exemplary embodiments, an exemplary report may include a detailed analysis of the sensory input (such as digital media) and highlights any forgeries found during the analysis. In some exemplary embodiments, an exemplary report may also provide visual evidence, collected from both exemplary models, exemplary evidence using statistical techniques, and exemplary textual contents to support the forensics. In some exemplary embodiments, an exemplary report may also include information about analysis methodology, and any limitations of the analysis.

In some exemplary embodiments, two types of authenticity reports may be generated either by respective data authenticity analysis unit and multimodal report generation units. In some exemplary embodiments, an exemplary system may utilize neuro-symbolic techniques to combine results from different AI models with symbolic reasoning techniques to increase the accuracy, interpretability, and explainability of the forensic analysis. In some exemplary embodiments, exemplary neuro-symbolic techniques help to integrate prior data-driven and human knowledge about what is genuine, and enable the knowledge infusion and reasoning abilities into the deep learning models, making them more generalizable, interpretable, and explainable. In some exemplary embodiments, data driven knowledge may be features, decisions, and multiple other biological cues such as emotions and temperature extracted from the data via AI models. In some exemplary embodiments, human knowledge may refer to the “rules, information, ranges, or ontology” that may be obtained from domain experts. For example, in emotions analysis, the knowledge of emotion changes from one state to another may be based on psychological knowledge.

Accordingly, in some exemplary embodiments, an exemplary system may be used by law enforcement agencies, courts, attorneys, forensic investigators, and other legal professionals to analyze digital media or other sensory data and generate multimodal forensic reports.

Further details of exemplary embodiments are described in the context of the figures below. Each block displayed in the figures may represent a standalone or dependent unit, segment or portion of the executable instructions, inputs, and physical components for implementing exemplary embodiments.

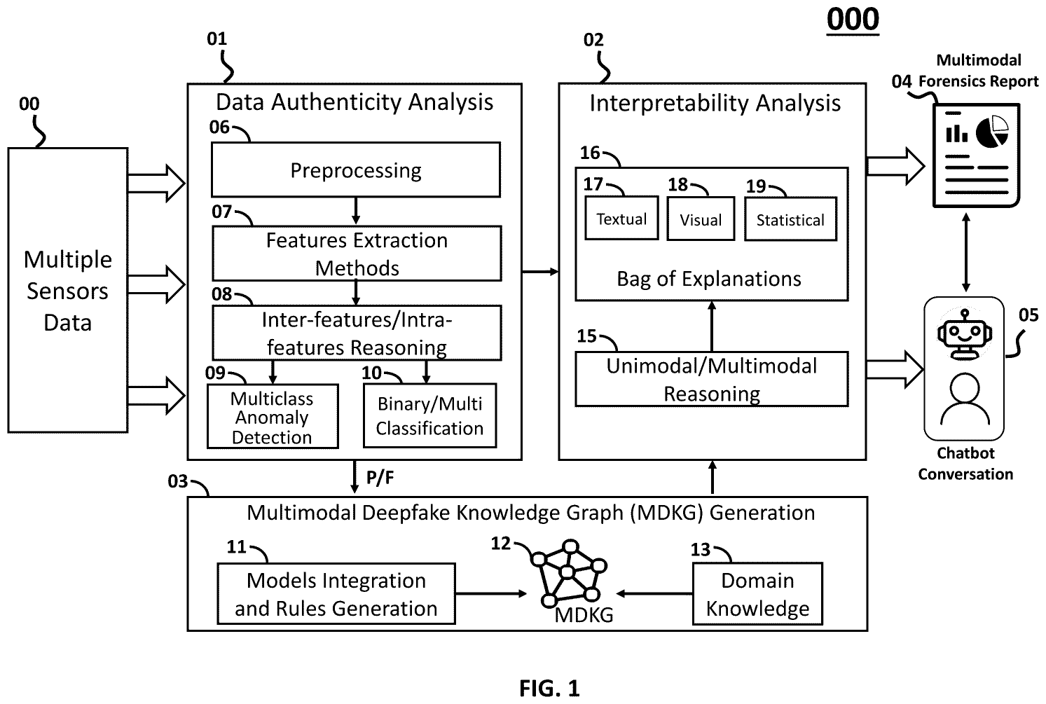

FIG. 1 illustrates a block diagram of a deep forgery detection system 000, consistent with one or more exemplary embodiments of the present disclosure. In an exemplary embodiment, multiple sensors data 00 may be input or received by data authenticity analysis unit 01. In an exemplary embodiment, multiple sensors data 00 may refer to data captured by various types of sensors, this may include sensors capturing data associated with audio and videos. In some exemplary embodiments, multiple sensors data 00 may be received directly from sensors or may be retrieved from exemplary databases. In some exemplary embodiments, within data authenticity analysis unit 01, there may be a preprocessing unit 06, features descriptors unit 07, interfeature and intrafeature reasoning unit 08, anomaly detection unit 09, and binary/multi classification unit 10. In some exemplary embodiments, preprocessing unit 06 may function similar to preprocessing unit 201 described in further detail below.

In some exemplary embodiments, preprocessing unit 06 may be configured to standardize any input data for further processing. In an exemplary embodiment, preprocessing unit 06 may entail one or more processors utilizing software to change resolution, compress, etc. In some exemplary embodiments, an input video may be of any resolution or frame rate, or the input audio may have various compression codec, or stereo/mono. In some exemplary embodiments, preprocessing unit 06, may resize all the input videos into standard resolution based on face detection and cropping coordinates, while each audio file may be converted into mono channel at a sample rate of 16 kHz.

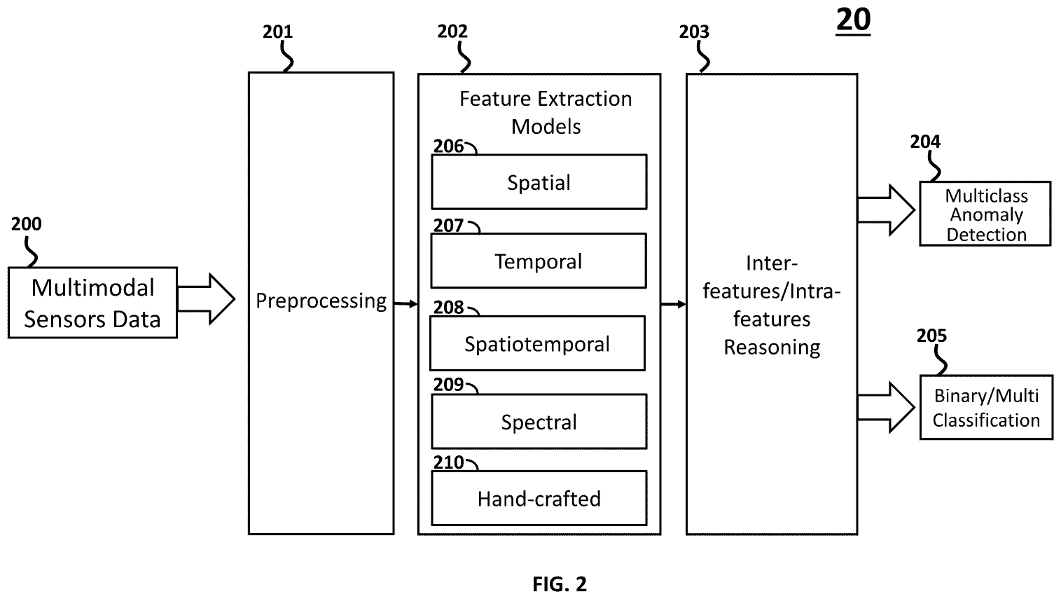

In some exemplary embodiments, feature extraction unit 07 may process standard input data for various feature extraction in spectral domain like flux, spatiotemporal such as MFCC for aural modality. In an exemplary embodiment, feature extraction unit 07 may extract similarly for visual modality such as biological features (i.e., emotions, temperature, lip-sync) or artifact based (blur, inconsistency, miss matching). In some exemplary embodiments, a detailed perspective on feature extraction unit 07 is provided further below in context of FIG. 2 and its accompany description.

In an exemplary embodiment, prior to forwarding an exemplary feature extraction to binary and multi-class classification unit 10, subsequent steps may be executed. In some exemplary embodiments, a fast correlation-based filter methodology may be utilized to eliminate highly correlated deep features from the collection of fused features, thereby retaining a maximum number of hand-crafted interpretable features. In some exemplary embodiments, a resulting feature extraction method, which may be referred to as a compact feature extractor, is subsequently forwarded to the classification head. In an exemplary embodiment, the equivalent of the remaining non-interpretable deep features (i.e., deep identity features) in the compact feature extractor may be approximated by finding their correlation with well-established hand-crafted temporal, spatial, and spatio-temporal features. In some exemplary embodiments, this exemplary modified feature set, which may be referred to as transformed interpreted features, may subsequently be forwarded to interfeature and intrafeature reasoning unit 08.

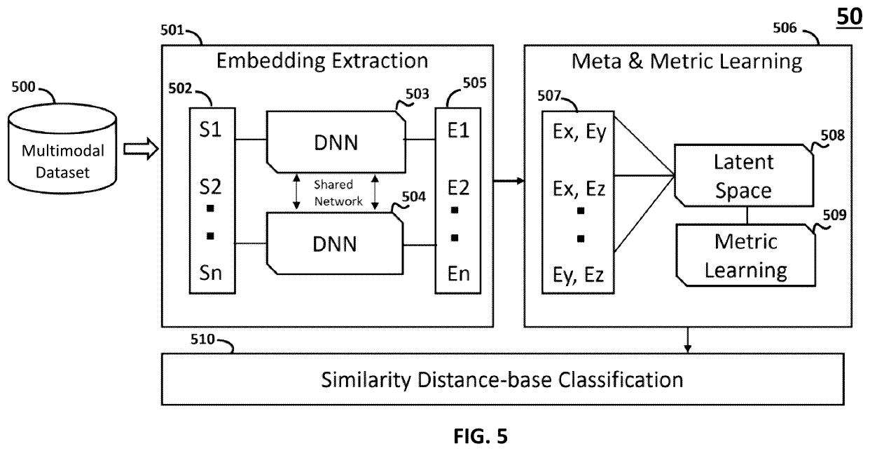

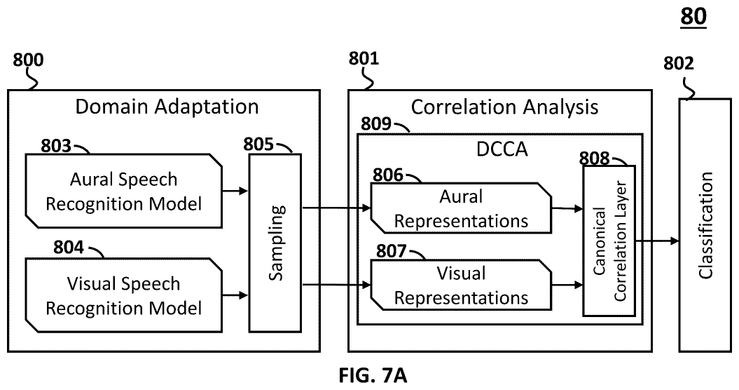

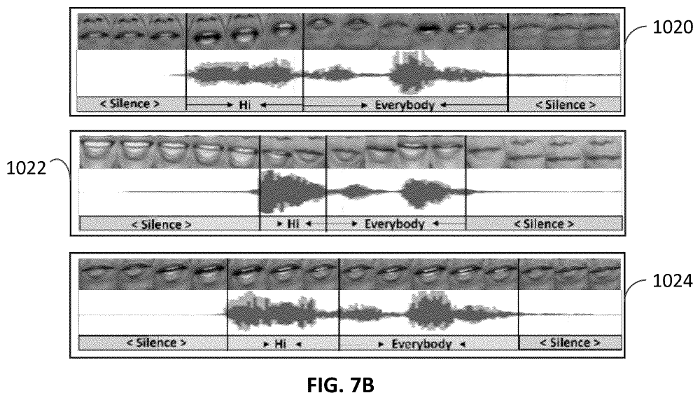

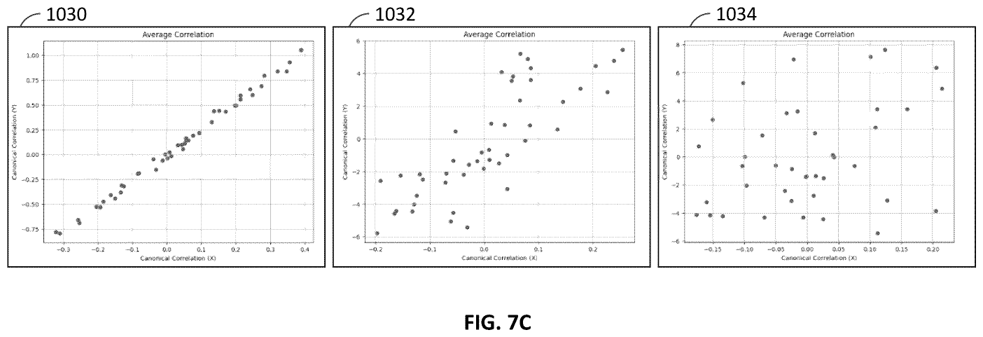

In an exemplary embodiments interfeature and intrafeature reasoning unit 08 may further process the extracted features from feature extraction unit 07 and may perform reasoning in uni- or multi-modal manner features to find highly correlated features That is, if the input media is a single modality (aural or visual) the reasoning may be performed based on various extracted features from consecutive frames of the same modality. For example, in the case of visual modality reasoning may be performed based on extracted features from visual modality such as facial expressions, deep features, or facial landmarks. In some exemplary embodiments, in a scenario where an input is video (i.e., audiovisual) then multimodal reasoning may be performed to analyze correlation between the modalities. For instance, facial landmarks and behavioral features from visual and spectrograms from audio modality to capture how facial behavior in visual may be correlated with emotions in audio modality. In an exemplary embodiment, further details with respect to interfeature and intrafeature reasoning are presented in further detail below with regards to descriptions accompanying FIGS. 5 and 7.

In an exemplary embodiment, Interfeature/intrafeature reasoning unit 08's output may be fed into anomaly detection unit 09 or binary/multi classification unit 10 depending on the extracted features. If the features are suitable for anomaly detection (i.e., mismatch in audio and visual modalities) anomaly detection unit may be activated to deal with it as regression problem. In some exemplary embodiments, in contrast to supervised learning techniques, effectiveness of exemplary meta-learning approaches utilized by anomaly detection unit 09 for anomaly detection may be performed through a multi-stage process. In some exemplary embodiments, this multi-stage process may involve the evaluation of the meta-learning model's performance, a comparative analysis against the supervised learning models, and the subsequent integration of the anomaly detection rules with rules generated by supervised learning. By incorporating the strengths of both supervised and meta-learning approaches, exemplary embodiments aim to achieve more robust and generalizable forgery detection capabilities including possibility of detecting zero-day forgery (such as deepfake) detection.

In some exemplary embodiments, in instances where extracted features are based on classification problems (i.e., artifact detection), then binary/multi classification unit 10 may be activated to classify the input media based on standard classifiers. In some exemplary embodiments, binary and multi-class classification models may be utilized to assess the probability of an item being authentic, tampered with, or untampered with. In contrast to traditional supervised learning techniques, the efficacy of exemplary meta-learning approaches for anomaly detection may be used through a multi-stage procedure. In some exemplary embodiments, this exemplary procedure may involve evaluating the performance of the meta-learning model and conducting a comparative analysis against supervised learning models. In some exemplary embodiments, the decisions derived from both meta-learning and supervised methods may be fused, and subsequently augmented with the rules present in an exemplary knowledgebase. Accordingly, in some exemplary embodiments, there is possibility that both anomaly detection and classification may be performed on single input as unimodal or multimodal.

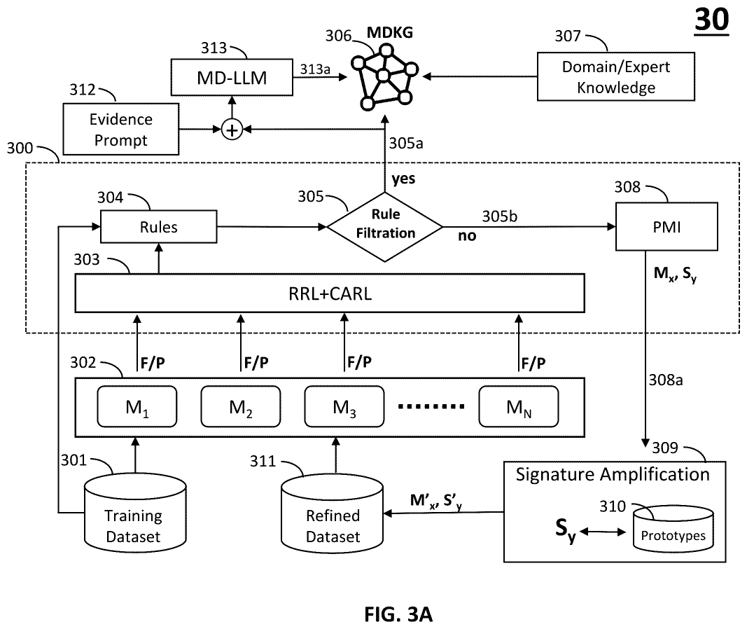

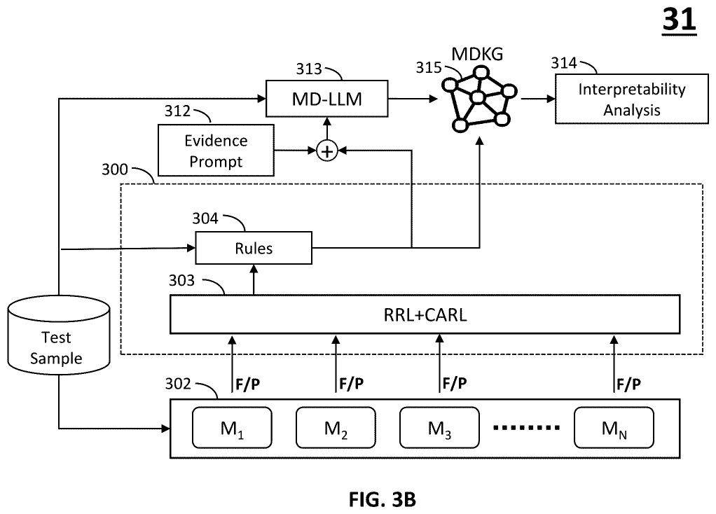

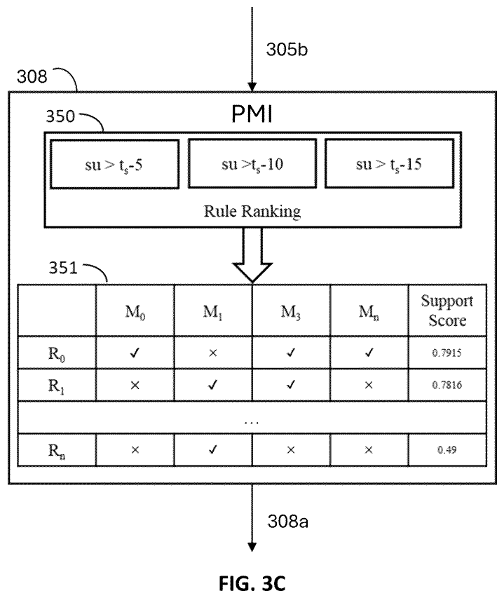

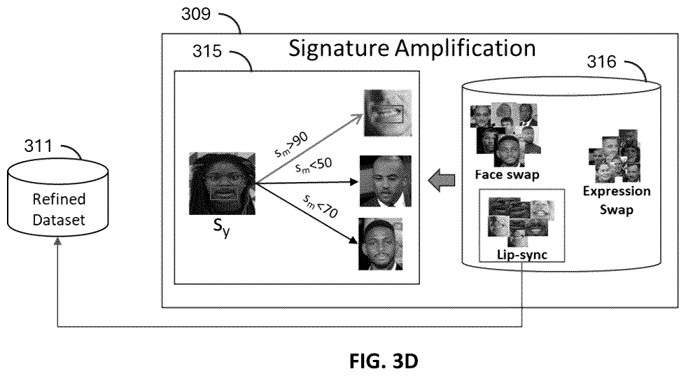

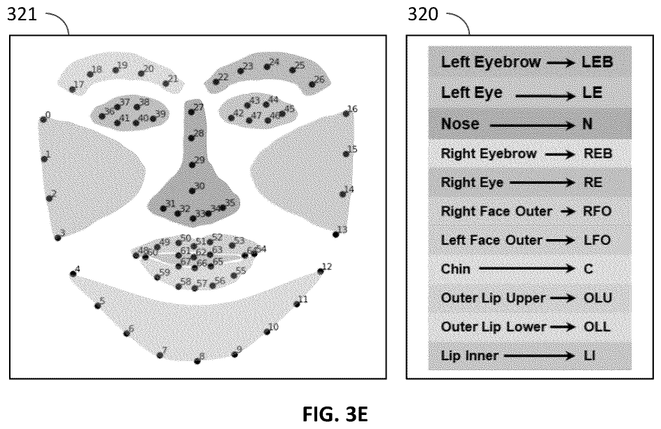

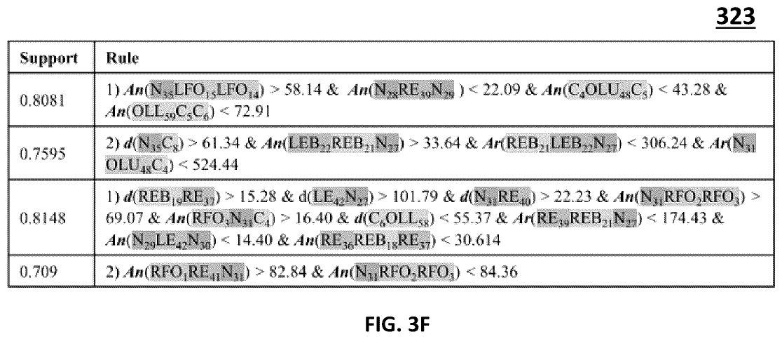

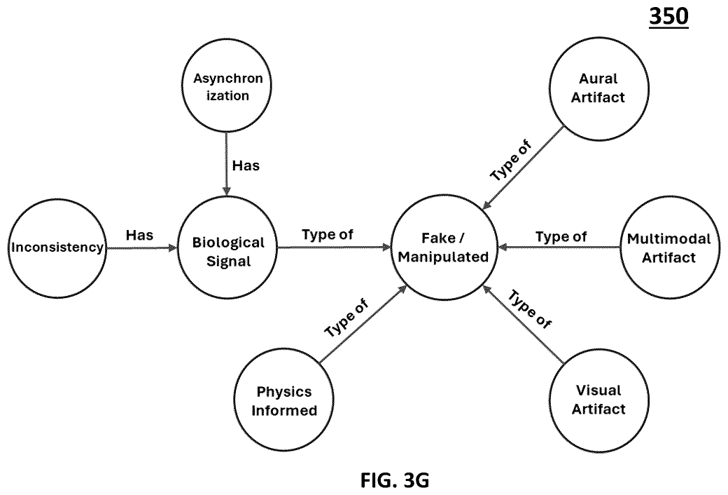

In some exemplary embodiments, for forgery detection using metric learning, system, may extract and analyze each channel separately if the input is multimodal. Additionally, the multimodal input may also be fed as it is to extract joint features space using feature extraction methods 07. In some exemplary embodiments, neural network and knowledge-based classification performs inter- and intra-modality reasoning on these multimodal features 08 including neuro-symbolic multimodal and single modality forgery detection 09, Neuro-symbolic Binary and multi-class classification 10. In an exemplary embodiment, resultant predictions with associated feature space (P/F) may then be forwarded to Multimodal Deepfake Knowledge Graph (MDFG) generation unit 03 which may forward the generated knowledge graph to the interpretability analysis 02 unit. The MDFG generation unit 03 may be responsible to extract rules-based data-driven knowledge 11 and domain knowledge 13 for reasoning, that is, it may be trained to extract such knowledge based on exemplary input. In an exemplary embodiment, FIG. 3A provides a block diagram 30 which may provide further details of the exemplary process of how the MDKG may be generated (that is, how it may be trained) and then how it may be utilized in unimodal and multimodal reasoning of various exemplary detection and interpretability units. In an exemplary embodiment, exemplary rules from MDKG that contain hierarchical and non-hierarchical relationships which may assist in obtaining different abstractions that may be passed to large language models or to generate forensic reports, such as multimodal forensics report 04.

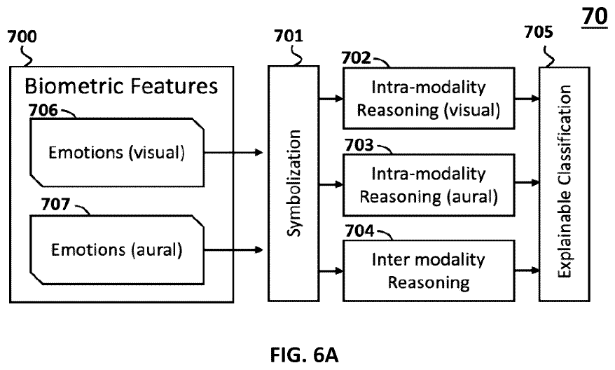

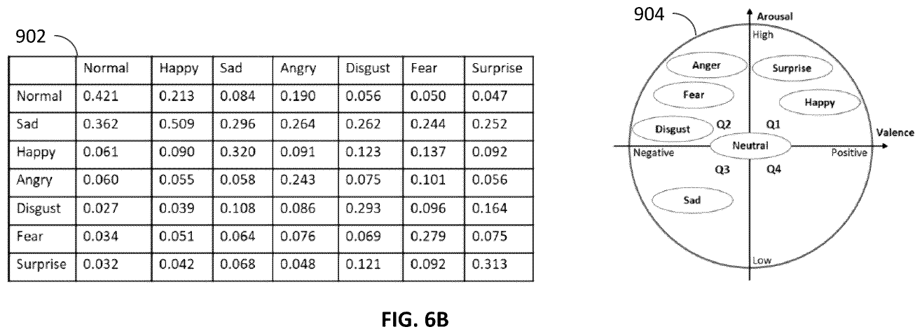

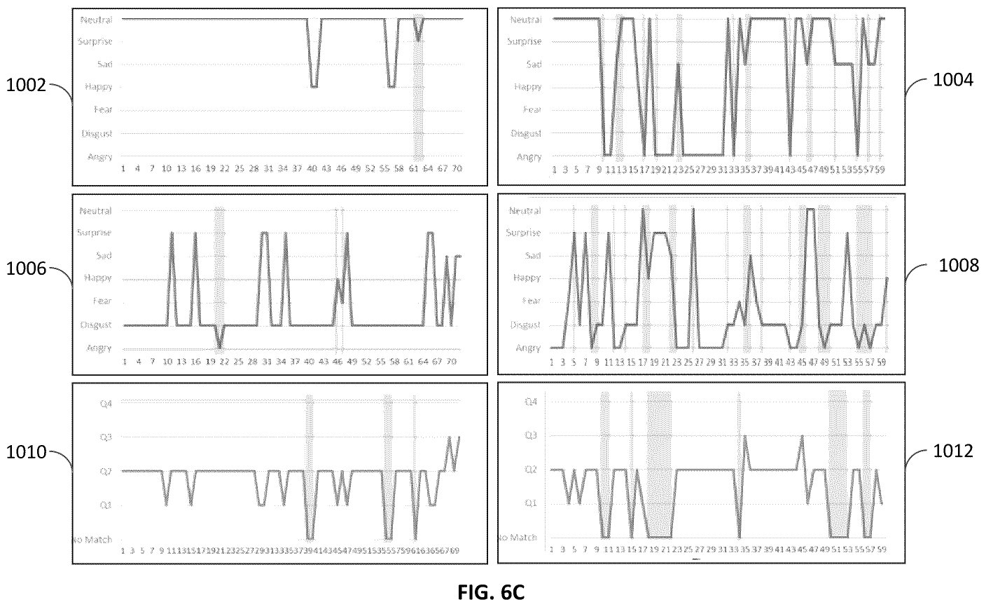

In an exemplary embodiment, once a knowledge graph is generated by MDKG generation unit 03, the original data from data authenticity analysis unit 01 along with MDKG from unit 03 may be provided to interpretability analysis unit 02. In an exemplary embodiment, utilizing exemplary generated rules (extracted features and generated knowledge) may be utilized by interpretability analysis unit 02 to generate explanations. In some exemplary embodiments, that may be independent of modalities and features dimensions and allow for performing and multimodal reasoning by unimodal/multimodal reasoning unit 15. For example, an exemplary scenario is illustrated in the description accompanying FIG. 6A where emotions are extracted from multimodal signals (facial expression from visual modality and speech emotions from aural modality) to perform reasoning over the rules defined in FIG. 6B. Specifically, in some exemplary embodiments, rules in FIG. 6B (902) may be used in intra-modality (unimodal) reasoning while rules defined in FIG. 6B (904) may be used in inter-modality (multimodal) reasoning.

In an exemplary embodiment, an exemplary resultant of reasoning may then be sorted, prioritized, and indexed with associated features as bag of explanations 16, that includes textual 17, visual 18, and statistical 19 facts. In some exemplary embodiments, bag of explanations 16 may include predictions and their confidence scores as textual explanations in form of annotated rules, heatmaps, artifact localization, face temperature visuals, and graphical representation of the emotions or lipsync as visual explanations 18. In an exemplary embodiment, exemplary explanations may then be retrieved based on a possible user or investigator's queries with chatbot 05 to generate personalized forensic report 04 explaining the authenticity of multimodal sensor data.

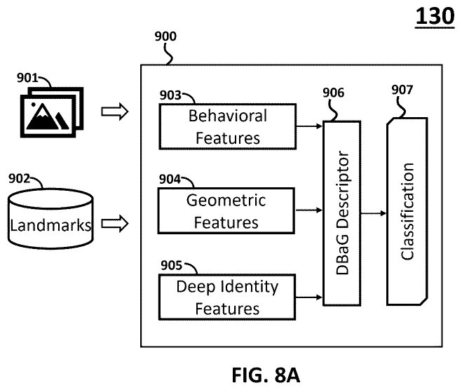

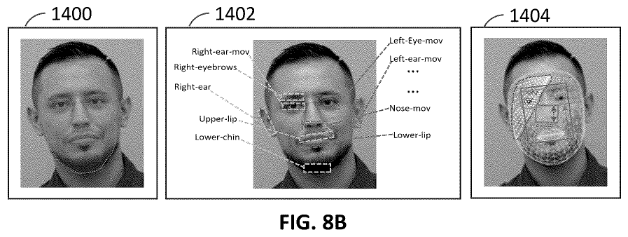

FIG. 2 illustrates a block diagram of an exemplary processing system for sensor data and forgery detection, consistent with one or more exemplary embodiments. In some exemplary embodiments, system 20 may be functionally and structurally similar to data authenticity analysis unit 01. In some exemplary embodiments, system 20 may consist of input of multimodal sensors data unit 200, preprocessing unit 201, interfeature and intrafeature reasoning unit 203, the multiclass anomaly detection unit 204 and binary or multiclass classification unit 205. In some exemplary embodiments, multimodal sensors data unit 200 may receive input from different data sources or modalities, such as audio and video. In some exemplary embodiments, pre-processing unit 201 may normalize received sensor data, and then provide it to models unit 202, from which modeled data is then reasoned by interfeature and intrafeature reasoning unit 203 and outputs forget detection and binary/multiclass classifications which may be stored in respective databases forgery detection 204 and binary/multiclass classification 205. In an exemplary embodiment, preprocessing unit 201 may prepare data for detection using relevant modalities. In an exemplary embodiment, the features unit 202 may contain various feature sets for performing detection over different modalities (i.e., audio only visual only, or audiovisual) including spatial 206, temporal 207, spatiotemporal 208, spectral 209, and hand-crafted 210. In an exemplary embodiment, further details regarding aspects of features extraction unit 202 are further explained in the context of FIGS. 5, 6, 7, and 8 and the accompanying text. In an exemplary embodiment, exemplary method illustrated in FIG. 5 may be associated with spectral 209 and handcrafted features 210, similarly exemplary method illustrated in FIG. 8A may be associated with spatiotemporal 208 features, exemplary methods illustrated in FIG. 6 may be based on temporal 207 and spatial 206, exemplary methods illustrated in FIG. 7A may be associated with temporal features 207, and exemplary methods illustrated in FIGS. 5 and 8A may be associated with spatial 206 and hand-crafted features 210.

Hand crafted features extractor may compose of pattern calculation operations which may refer to computational methods for extracting meaningful characteristics or patterns from data. These operations apply predefined algorithms to detect structural, statistical, or frequency-based features within data, such as edges in an image, frequency components in an audio signal, or temporal transitions in video. Examples of such operations include spectral representation with audio spectrograms, and frequency-based analysis using zero-crossing rate in audio signals.

In some exemplary embodiments, feature sets for spatial 206 may refer to individual frames in a video. In some exemplary embodiments, this may refer to a facial artifact or incomplete face part in a still image (single frame) of a video that may be detected as facial landmarks or deep features.

In some exemplary embodiments, feature sets for temporal 207 may refer to changes between consecutive frames such as inconsistent emotions or sudden/abrupt change in facial geometry. In some exemplary embodiments, further exemplary details with regards to temporal 207 are provided in further detail below in FIG. 6A.

In some exemplary embodiments, feature sets for spatiotemporal 208 may refer to stack of frames that analyze anomalies in still images (video frames) as well as the difference between consecutive frames such as talking behavior.

In some exemplary embodiments, feature sets for spectral 209 may refer to frequency domain features, especially when the audio signals are converted into spectrograms and treated as an image in the neural network. In some exemplary embodiments, feature sets for hand-crafted 210 may refer to facial landmarks which may be further expanded into geometric features including distances between two parts of face, angle between them, or rectangular area form using various landmarks.

In some exemplary embodiments, biological features may refer to any feature that is inspired from human behavior, for example, facial temperature and detected emotions as human biometric signature as these characteristics are hard to mimic in generating fake media.

In some exemplary embodiments, interfeature and intrafeature reasoning unit 203 may provide two respective outputs as correlated features to anomaly detection 204 and binary/multi classification 205. In some exemplary embodiments, anomaly detection 204 may refer to FIG. 5 while binary/multi classification 205 may refer to FIGS. 6A, and 8A. In some exemplary embodiments, being robust to unseen types of forged data, forgery detection by utilizing exemplary learning helps identify data that is significantly different from what is expected or “normal.” Furthermore, in some exemplary embodiments, classification, on the other hand, categorizes data into distinct classes and is good for previously known types of attacks.

FIG. 3A illustrated a block diagram providing insight into an exemplary Multimodal Deepfake Knowledge Graph (MDKG) Generation process. In an exemplary embodiment, an exemplary overall process may be described as a training mechanism for integrating unimodal and multimodal deepfake detection models using neuro-symbolic reasoning architecture consistent with one or more exemplary embodiments of the present disclosure. In an exemplary embodiment, an exemplary architecture may leverage a rule generation model 300 comprising of RRL and CARL unit 303 and a PMI (Prioritization Model Indices) unit 308 to enhance the detection and interpretability of the deepfake contents.

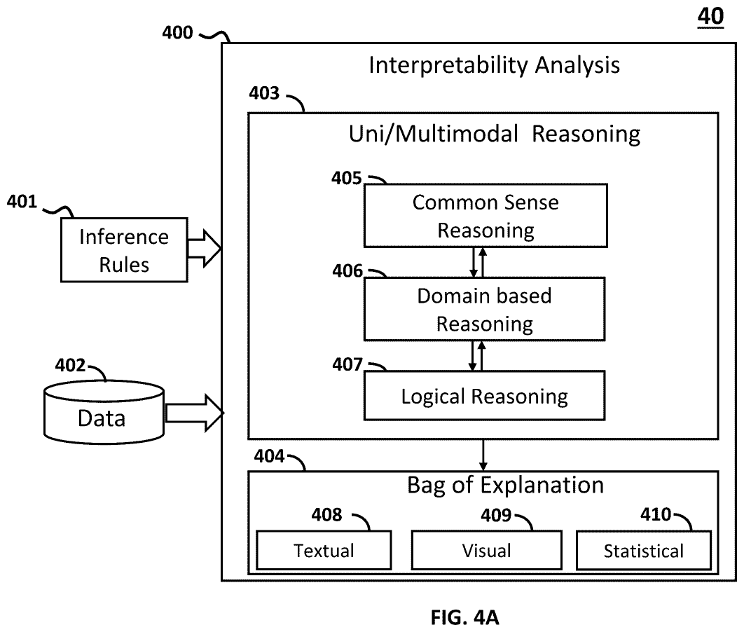

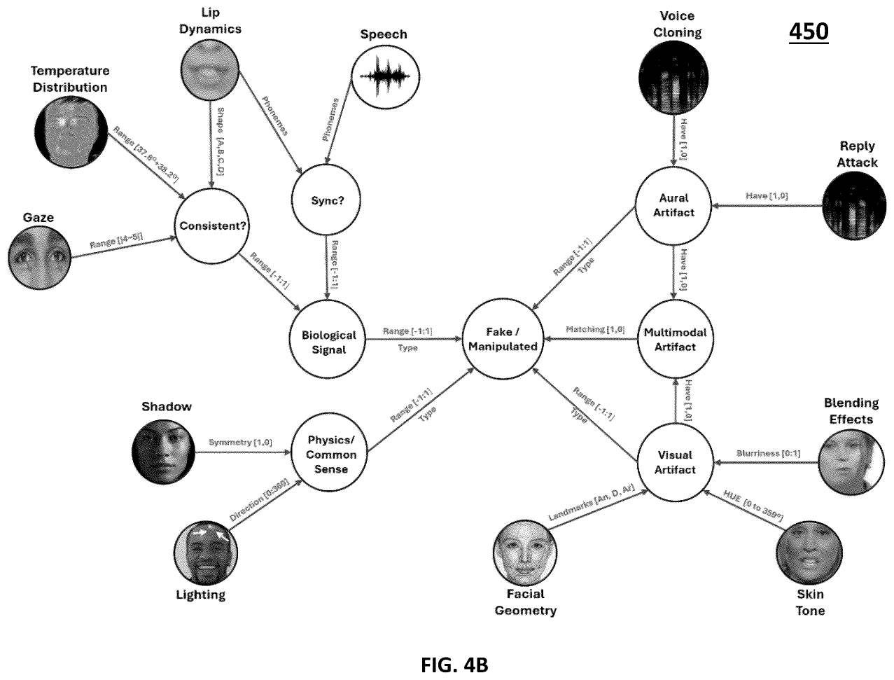

In an exemplary embodiment, an exemplary training process of MDKG generation may be initiated from the training datasets 301 which may comprise of sensory data (e.g. video/audio) that may be labeled as fake or real. In an exemplary embodiment, models 302 may include supervised, semi-supervised, and unsupervised machine learning, deep learning and neuro-symbolic models. In an exemplary embodiment, parts of video data may be labeled fake or real, that is, parts of a video may be real, and parts may be fake. In an exemplary embodiment, the data within training dataset 301 may be similar to data of multiple sensors data 00 of FIG. 1 and multisensory data 200 of FIG. 2. In an exemplary embodiment, training dataset 301 may contain deepfake samples across multiple modalities (audio, visual and multimodal) encompassing different tasks. In an exemplary embodiment, training dataset 301 may serve as the foundational source for generation of MDKG. In an exemplary embodiment, MDKG may refer to a knowledge graph specifically designed for multimodal deepfake detection. In an exemplary embodiment, an exemplary knowledge graph may integrate data from different modalities (e.g., audio, video, and sensor data) and provides a structured framework to detect and analyze deepfake content by reasoning over multimodal inputs. In an exemplary embodiment, an exemplary MDKG may link information from various data streams (e.g., audio and video) to detect inconsistencies or manipulations. Furthermore, in an exemplary embodiment, by analyzing relationships between different types of data (such as lip movements in video and corresponding audio), an exemplary knowledge graph may help identify potential manipulations like lip-syncing errors in deepfake videos. Furthermore, an exemplary MDKG may also provide explainable insights, allowing the system to describe why a particular piece of content was flagged as manipulated based on the patterns and rules stored in an exemplary knowledge graph. In summary, exemplary MDKG may enhance an exemplary deepfake detection process by integrating multimodal data, reasoning over correlations and discrepancies, and offering clear explanations for detection outcomes. In an exemplary embodiment, details of MDKG are provided in further detail with respect to FIG. 4B.

In an exemplary embodiment, models 302 which may allow for feature extraction and prediction (F/P) may have the same functionality as unit 202 of FIG. 2. Each model (i.e., M₁, M₂ . . . . M_{N}) of models 302 may be categorized or similar to supervised or semi-supervised machine learning based on hand-crafted features or deep learning models that may capture significant aspects of the input signals. Alongside the hand-crafted or deep feature extraction, these models also made a prediction based on each specific modality and task to classify the data instances into real or manipulated/generated.

In an exemplary embodiment, Rule-Based Representation Learning (RRL) and Correlation-Aware Rule Learning (CARL) 303 may refer to a classifier designed to learn interpretable, non-fuzzy rules for representation and classification automatically. The generated rules 304 from RRL and CARL 303 may be validated using the ground truth labels from training dataset 301, that is, the predictions of RRL and CARL 303 are confirmed based on known ground truth labels of training dataset 301 and weights associated with predictions may be updated on an iterative basis using back propagation. Accordingly, rules 305 may be able to predict the relationships between different features/modalities such as geometrical/behavioral or audio/video synchronization inconsistencies. These rules are generated based on ontology whose excerpt is given in FIG. 3G.

In an exemplary embodiment, an exemplary process may utilize rules filtration 305 for filtering the rules generated by the RRL and CARL 303 unit. In an exemplary embodiment, RRL and CARL 303 may generate rules 304 which include an exemplary support score for each rule. In an exemplary embodiment, based on a threshold associated with the support score, generated rules 304 may be classified into two types after filtration:
Type 1-Rules that meet the support criteria: These high-confidence rules reflect robust patterns between input features and predictions and are incorporated into the knowledge graph MDKG 306 as well as MD-LLM 313. In an exemplary embodiment, high-confidence rules may refer to support score higher than a certain threshold, for example, greater than 80 percent of a total score or 0.8.
Type 2-Rules that do not meet the support criteria: These low-confidence rules are flagged as unreliable and excluded from further processing, requiring refinement or retraining. In an exemplary embodiment, low-confidence rules may refer to support scores lower than a certain threshold of Type 1 rules, for example, lower than 80 percent of a total score or 0.8.

In an exemplary embodiment, the Type 2 rules may pass to a PMI (Prioritization Model Indices) unit 308, designed to identify which model, among an array of models, is responsible for misclassifying the input sample. PMI unit 308 may identify the specific model (Mₓ) that produces the incorrect classification and may pinpoint the misclassified sample (S_{y}). In an exemplary embodiment, FIG. 3C provided details of PMI unit 308 in further detail. Output 308a from PMI 308 may be forwarded to the Signature Amplification unit 309 where prototype 310 based augmentation or sample refining may be performed based on similarity measurement methods comprising of Euclidian distance and cosine similarity for misclassified samples and refined dataset 311 may be developed for next iteration of training. In this way, each iteration may amplify some of the misclassified samples using prototype learning and these iterations will cease when one of the following criteria is met:
If three consecutive integrations result in no contribution to increasing the support score for the specified rules.
If the overall performance of the system on a certain amplified dataset does not lead to improved accuracy (i.e., greater than previous iteration).

In an exemplary embodiment, FIG. 3C describes an exemplary process of critical analysis of the generated rules 305b. In an exemplary embodiment, generated rules 305b may be similar to data driven knowledge. In an exemplary embodiment, input to PMI unit 308 may be the type 2 rules that have not been selected for integration into the MDKG, that is 305b. These rules may pass to a PMI unit 308, that is designed to prioritize rules 305b based on support score (su) 350 and the number of models involved in rule(s) 351. To achieve this, the PMI unit 308 performs the prioritization of these rules in two steps: 1) first, it prioritizes the rules with higher support 350, which are close to the threshold set for the rules filtration module. For instance, it applies a threshold of varying levels, such as tₛ-5, tₛ-10, tₛ-15, to filter out rules. Hence, su>tₛ-5 means all the rules having support scores greater than tₛ-5 (i.e., if tₛ=80, then tₛ-5=75). In the second step, it evaluates the rate of amplification required for the rules in terms of model involvement 351. In the table 351, V and X indicate whether the corresponding models is contributing to the generation of a given rule (i.e., R₀, R₁, . . . . Rₙ) or not, respectively. These rules are analyzed with respect to the current sample that may belong to a uni or multimodal input. These rules prioritization helps optimize the training and strength MDKG by incorporating rules with high support score. For instance, if five tiers of samples subsets are created for amplification, after the first iteration of amplification, the performance of the system is evaluated, and the new rules that match the support criteria (≥80% support) will be added to the knowledge graph, while the rest will be routed back to the PMI modules. Before moving to the second iteration, the rules are prioritized again concerning their support ratio and model involvement, and then the new samples subset batch is forwarded for amplification. In an exemplary embodiment, output of PMI unit 308 may be a pair (Mₓ,S_{y}) where Mₓ represents the model and S_{y} represents the input sample. This output is crucial for tracking model performance and refining rule applications.

FIG. 3D explains details of an exemplary signature amplification 309 process. Input to signature amplification 309 is the model and sample indexes (Mₓ,S_{y}). In an exemplary embodiment, the sample may be retrieved from the training dataset using an exemplary index for similarity analysis. In an exemplary embodiment, similarity analysis 315 may collaborate with prototypes 316 to enhance model accuracy for misclassified samples. In some exemplary embodiments, prototypes 316 may guide this process by providing reference patterns that may represent known types of deepfake attacks. In an exemplary embodiment, similarity unit may comprise a set of ‘n’ prototype vectors, strategically positioned within the latent space to encapsulate distinct activation patterns as observed in the feature maps. The Euclidean distance is computed between each prototype vector and individual patches within the input feature map, thereby generating ‘n’ similarity maps. These similarity maps facilitate the identification of prototypical features present within the image. Subsequently, global max pooling is applied to the similarity maps, yielding singular similarity scores for each prototype, which quantitatively represent the intensity of prototypical features associated with specific image patches. The prototype corresponding to the maximum pooled similarity score is thus included the refined dataset 311.

In an exemplary embodiment, prototypes 316 in FIG. 3D may include Faceswap, LipSync, and Expression Swap examples. By comparing the enhanced signatures with these validated prototypes, system 30 may ensure that the amplified features are meaningful and relevant. In an exemplary embodiment, based on the similarity analysis, the selected cluster with similar features may be forwarded to the refined dataset for next (e.g., 2nd) iteration of training. In an exemplary embodiment, PMI and Signature amplification together may refine the dataset to better highlight essential characteristics of different deepfake attack types, ultimately improving the detection model's ability to recognize subtle features of fake contents.

In an exemplary embodiment, the enhanced features may be stored in refined dataset 311, which may contain improved data that highlights important characteristics for detecting deepfakes. These enhanced features may play a crucial role in enriching the knowledge graph with more accurate and detailed information about the attack types and modalities.

In an exemplary embodiment, after exemplary neural networks in models 302 such as M₁, M₂ . . . . M_{N} have been updated using the Type 2 rules and enhanced features, an exemplary system unit 300 may perform a re-evaluation. In an exemplary embodiment, exemplary updated data, as well as the previous rules that met the support criteria (Type 1), may be tested again using an exemplary model. In an exemplary embodiment, this ensures that the models maintain consistency and accuracy with the previously supported rules (Type 1), even after updates. At the same time, an exemplary system may check if the new features from the enhanced dataset and updated models may now meet the support criteria for previously failed rules (Type 2) to integrate them in the MDKG 306.

In an exemplary embodiment, an exemplary training process may repeat, with each iteration improving an exemplary neural network by focusing only on the rules that did not meet the support criteria in previous rounds, that is, exemplary models within models 302 improve and the enhanced data is incorporated, more and more rules are expected to meet the support criteria in subsequent iterations. Over time, fewer rules fall into the Type 2 category, as an exemplary model becomes more accurate and reliable, contributing to a progressively better understanding of deepfake detection across modalities.

FIGS. 3E and 3F illustrate some examples of the rules generation based on one of the detection models (handcrafted/landmarks features). For instance, first a facial landmark-based vocabulary may be developed based on the landmarks covering a part of face. For instance, landmark 17 to 21 extracted using dlib library collectively represents a right eyebrow. In an exemplary embodiment, during inference, various geometrical features based on this vocabulary may be extracted to fed into RRL or CARL 303. FIG. 3E illustrates the developed facial vocabulary 320 for deepfake detection domain. For example, the specified rules may check the facial geometry features formed by landmarks for specific individuals satisfy certain threshold. In an exemplary embodiment, landmark vocabulary represented in domain ontology may be used for mapping between facial landmark regions 321 (e.g., eyebrows, eyes, nose, lips) and their corresponding landmark indices/vocabulary. In an exemplary embodiment, FIG. 3F. illustrates table 323 with extracted rules where the first rules are explained as an example below:
An (N₃₅LFO₁₅LFO₁₄)>58.14 & An (N₂₈RE₃₉N₂₉)<22.09 & An (C₄OLU₄₈C₅)<43.287 & An (OLL₅₉ C₅ C₆)<72.91

In an exemplary embodiment, exemplary rule listed above may involve checking specific angles between facial landmarks (e.g., nose, face-outer region, eyes, lips) such as N₃₅LFO₁₅LFO₁₄ angle>58, whereN₃₅ represents a landmark on the nose, and LFO₁₅ and LFO₁₄ may be landmarks on the left face's outer region. In an exemplary embodiment, this exemplary rule states that this angle between N₃₅ LFO₁₅ and LFO₁₅ LFO₁₄ must be greater than 58.146 degrees for a real face. In an exemplary embodiment, exemplary databases may contain analogous or similar rules for audio-based or audio-visual based features. In an exemplary embodiment, similar rules may be extracted for audio-based or audio-visual signals to detect tampering. For example, first, an audio-based vocabulary may be developed based on critical features such as rhythm and tonal attributes. For instance, a vocabulary for rhythm may include an exemplary tempogram and its peaks across different time segments, while the tonal vocabulary may include chroma features extracted with temporal coherence penalty differences and zero-crossing rates (ZCR) with frequency deviation penalty. Subsequently, speech tampering detection (STD) descriptor with MFCC, IMFCC, and deep representation features derived from this exemplary vocabulary may be extracted to formulate rules within RRL or CARL for tampering detection. In an exemplary embodiment, exemplary rules may be designed to ensure that the rhythmic and tonal consistency of an audio signal fall within expected thresholds for untampered audio. The following exemplary rule may check that certain feature relationships meet predefined thresholds to identify discrepancies in rhythmic and tonal consistency:
TP (S₁, S₂)≤1.0 & CV (F1, F2)<0.1 & ZCR (20 ms)≤ZCR Mean

In an exemplary embodiment, this rule may involve checking the ratio between tempogram peaks (TP) in two non-overlapping time segments of an exemplary audio signal, such as TP (S₁, S₂)≤1.0, where S₁ and S₂ represent time segments. The rule further states that the variance in chroma (CV) between adjacent audio frames F1 and F2 should be less than 0.1 (i.e., CV (F1, F2)<0.1). Furthermore, the zero-crossing rate (ZCR) in any 20-millisecond window must not exceed the mean ZCR for the entire audio segment (i.e., ZCR (20 ms)≤ZCR_Mean). The exemplary specified rule may ensure that tampered segments of the audio signal may be detected by analyzing deviations in rhythmic and tonal consistency.

In an exemplary embodiment, the MD-LLM (Multimodal Deepfake Large Language Model) 313 is a deep learning model designed to generate descriptive rules for deepfake detection by leveraging multimodal data, including images, audio, and textual explanations (query/response pairs). The query/response generation may involve template based conversion of the Type 1 rules. In an exemplary embodiment, it is fine-tuned on extensive multimodal deepfake datasets, enabling it to identify and interpret the patterns across various input modalities. In an exemplary embodiment, when given an input image, MD-LLM 313 is capable of generating descriptive rules using its learned knowledge to analyze the visual features, such as unnatural facial movements, distorted geometry, which are characteristics of deepfake. This enables MD-LLM 313 to recognize the typical patterns of real and manipulated content across different modalities. In an exemplary embodiment, Query and expected Response from MD-LLM 313 for geometric features can be:
Query: “Examine the facial geometry for natural alignment, paying attention to angles, distances, and proportions between key landmarks. Look for any distortions or asymmetries in the face, such as unusual angles or disproportionate spacing between features like the eyes, nose, and mouth. Check for smooth contours and proper symmetry, as deepfakes often exhibit unnatural facial distortions or misalignments.”
Response: “The face in the image exhibits unnatural facial geometry. The angles between key landmarks, such as the eyes, nose, and mouth, are distorted, which is characteristic of deepfakes. Specifically, the distance between the eyes is wider than natural proportions, and the spacing between the nose and mouth is inconsistent with typical human facial features. Additionally, the contours of the face, particularly around the jawline and cheekbones, show irregularities that suggest a lack of smooth, natural curvature, common in manipulated faces. Facial symmetry is also off, with one side of the face noticeably misaligned compared to the other. These signs of facial distortion and misalignment indicate that the image is likely a deepfake.”

In an exemplary embodiment, queries and responses serve as the fundamental components in training a MD-LLM (Multimodal Large Language Model) 313. In an exemplary embodiment, a query is a structured input that asks the model to focus on specific aspects of data, such as analyzing facial geometry or identifying distortions in an image. The response, in turn, is the expected output from the model which we term as a descriptive rule. This provides a detailed explanation based on the patterns it has learned from the training data.

In an exemplary embodiment, ground truth, type of forgery, and modality (audio, visual) information is passed to a large language model to generate queries that constitute the evidence prompt 312. In an exemplary embodiment, the evidence prompt 312 is designed by focusing on specific features of multimodal and unimodal deepfake analysis, such as speech frequencies, geometric distortions, out-of-sync lip movement, or unnatural alignments in facial structures. In an exemplary embodiment, for a given image, evidence prompt 312 is crafted to guide the MD-LLM 313 to analyze critical visual attributes, including angles, distances, and proportions between key landmarks, based on known patterns of real and manipulated faces. In an exemplary embodiment, the evidence prompt is carefully aligned with the Type 1 rules 305a, ensuring that the descriptive rules 313a produced by the MD-LLM 313 are both contextually relevant and grounded in the geometric relationships and visual inconsistencies identified in the input data.

In an exemplary embodiment, the rules generated through fine-tuned MD-LLM 313 are integrated into the MDKG 306 construction pipeline. In an exemplary embodiment, the Type 1 rule, after being filtered through the rules filtration process 305 can be represented as:
An (N 35 LFO 15 LFO 14)>58.14 & An (N 28 RE 39 N 29)<22.09 & An (C 4 OLU 48 C 5)<43.287 & An (OLL 59 C 5 C 6)<72.91

In an exemplary embodiment, for the previously stated Type 1 rule the query from evidence prompt 312 can be:
Query: “Examine the facial geometry for natural alignment, paying attention to angles, distances, and proportions between key landmarks. Look for any distortions or asymmetries in the face, such as unusual angles or disproportionate spacing between features like the eyes, nose, and mouth. Check for smooth contours and proper symmetry, as deepfakes often exhibit unnatural facial distortions or misalignments.”

In an exemplary embodiment, the descriptive rule 313a can be:
Response: “The angle between the nose (N 35) and the left outer face regions (LFO 15, LFO 14) should exceed 58.14 degrees, indicating a natural alignment of the nose and surrounding areas. Additionally, the distance between the nose and eyes (N 28, RE 39, N 29) should be less than 22.09 degrees, ensuring typical spacing between these features. The jawline and cheek contours, formed by landmarks such as C 4, OLU 48, and C 5, should maintain an angle of less than 43.287 degrees, ensuring smooth, natural curves. Lastly, the angle between the outer cheek and jawline landmarks (OLL 59, C 5, C 6) must be less than 72.91 degrees to maintain overall facial symmetry. Any significant deviations from these geometric relationships, such as exaggerated angles or irregular feature spacing, suggest potential distortions or deepfake manipulation.”

In an exemplary embodiment, the generalized knowledge from MD-LLM 313 is generated by leveraging the Type 1 rules 305a and evidence prompts 312, enabling it to generate more descriptive rules 313a. The resulting rules, which now encapsulate both Type 1 rules 305a and 313a rules, are stored in the Multimodal Deepfake Knowledge Graph (MDKG) 306.

In an exemplary embodiment, in parallel, the MDKG 306 may be further generated by utilizing domain knowledge 307 that is composed of deepfake ontology to further refine the relationship of each node of the MDKG 306. FIG. 3G illustrates a possible example of the ontology 350 for deepfake detection, which serves as base for the domain knowledge 307, consistent with one more exemplary embodiments of the present disclosure. In an exemplary embodiment, ontology 350 may include various types of detection models' features categorized into biological, aural, visual, multimodal, and physics informed artifacts. In an exemplary embodiment, these exemplary categories represent the different aspects of analysis performed on media content to detect potential manipulation. In an exemplary embodiment, each exemplary node in the ontology may represent a core concept, and respective edges describe the relationships between these concepts. In an exemplary embodiment, ontology 350 may enable structured reasoning about the nature of potential deepfakes. As an exemplary, in further detail, biological signal node may capture inconsistencies within biological cues, such as lip movement, gaze, or temperature distribution of a face or detecting asynchronization between lips movement (visual) and spoken words (aural) or emotions detected in different modalities. Similarly, visual and aural artifacts nodes may analyze any input data related to media with features related to the visual artifacts such as skin tone color, blurriness, etc. In an exemplary embodiment, multimodal artifacts may also be considered, where inconsistencies across different modalities, such as audio-visual alignment or sensor data mismatches, further suggest the presence of manipulation. In an exemplary embodiment, physics informed manipulation detection models may refer to exemplary models that may analyze any given media based on common physics principles such as light and shadow directions etc. In an exemplary embodiment, combined, these categories may form ontology 350 of deepfake detection domain which help to interact and reason over manipulated media.

In some exemplary embodiments, domain knowledge 307 may refer to information or insight provided by experts which may include lawyers, psychologists, forensic expert or any relevant body with domain relevance. In some exemplary embodiments, domain knowledge 307 may provide expert knowledge such as in case of a psychologist, what may describe facial behavior of a normal person while talking or in specific emotion. Ontology represents the domain vocabulary while knowledge graph stores the facts about fake and real sensory data following the constraints defined in the ontology. In some exemplary embodiments, FIG. 6B. provides table 902 as an example of knowledge where probabilities of changing emotion from one emotion state to another are given in a structured way. For example, chart 904 represents a quadrant-based representation to represent multimodal emotion for all possible combination according to the expert knowledge (domain expert).

FIG. 3B illustrates the inference process of the MD-LLM 313 and rule-based reasoning to compare derived insights with the MDKG 306. In an exemplary embodiment, the test sample 314 serves as the input to a set of specialized models M₁,M₂, . . . ,M_{N} each generating features or predictions (F/P). These outputs are aggregated in the RRL+CARL 303. In an exemplary embodiment, the RRL+CARL system leverages Context-Aware Representation Learning (CARL) and Rule-Based Representation. In an exemplary embodiment, the rules from 304 are used in conjunction with evidence prompts 312 to provide contextualized input to the MD-LLM 313. The evidence prompts are structured queries that align with the rules from 304. In an exemplary embodiment, the MD-LLM 313 processes these prompts and generates descriptive rules 313a. Both rules 313a from MD-LLM 313 and rules 304 are passed to the interpretability analysis module 314 for final prediction and report generation, which have the same functionality as FIG. 4A.

FIG. 4A illustrates various components of the interpretability analysis unit 400, consistent with one or more exemplary embodiments of the present disclosure. In some exemplary embodiments, input to interpretability analysis unit 400 may be the data 402 which is the same data in 00 and inference rules 401. In some exemplary embodiments, interpretability analysis unit 400 may include unimodal or multimodal reasoning 403 based on MDKG. This MDKG may have the same functionality as of the unit 306 of FIG. 3A that may be used directly for report generation. In an exemplary embodiment, symbolization may be performed which is the initial step for reasoning by converting the unimodal or multimodal features from various models into a set of symbolic representation prior to rules generation. In an exemplary embodiment, as provided below, equations 11 and 12 may represent an example of features symbolization where extracted emotions from visual and aural channels may be converted into symbolic representation over time, consistent with one or more exemplary embodiment of the present disclosure.

In some exemplary embodiments, uni/multimodal reasoning unit 403 may further include common sense reasoning 405, domain based reasoning 406, and logical reasoning 407 in the form of Multimodal Deepfake Knowledge Graph (MDKG). Examples of common sense reasoning 405, domain based reasoning 406, and logical reasoning 407 are given below in the description of FIG. 4B.

In an exemplary embodiment, FIG. 4B. illustrates an excerpt of Multimodal Deepfake Knowledge Graph 450 combining deepfake detection model outputs, consistent with one more exemplary embodiments of the present disclosure. In an exemplary embodiment, primary function of this exemplary knowledge graph may be to enable unimodal and multimodal reasoning of unit 403 to analyze different aspects of a potentially fake or manipulated sample. In an exemplary model, the MDKG may have the combined results from exemplary detection models, an exemplar system may improve its ability to identify deepfakes across different modalities based on various common sense, domain-specific, and logical reasoning.

In an exemplary embodiment, the Multimodal Deepfake Knowledge Graph 450 may consist of nodes representing, biological signals, physics aware artifacts, in the detection pipeline, as well as aural, visual, and multimodal artifacts that are common in fake or manipulated media. In an exemplary embodiment, these exemplary nodes may be connected via edges that represent relationships or dependencies between different aspects of the data. In an exemplary embodiment, the overall structure may enable cross-modal correlation or reasoning that may improve the ensembled detection accuracy and explainability.

In an exemplary embodiment, Multimodal Deepfake Knowledge Graph 450 may include rules extracted using biological signal based methods that may be responsible for analyzing various biological cues, such as lip dynamics, gaze, and speech. In an exemplary embodiment, this node may determine whether these signals are consistent with natural human behavior. For example: for the lip dynamics, the shape of the lips during speech is analyzed to ensuring the lips move naturally in sync with the audio phonemes. Similarly, in the case of gaze analysis, the eye movements are checked for natural patterns, within a predefined range. This category lies in the logical reasoning unit 407. In an exemplary embodiment, an exemplary second category of the detection models may be physics aware (common sense) based methods that analyze environmental factors such as lighting and shadow, etc. In an exemplary embodiment, models to detect common sense may be trained utilizing labeled datasets specifically having artifacts related to lighting conditions, that is, labels that include what parts of an image includes shadows or light, etc. Moreover, the category of visual artifacts-based (domain reasoning) methods may be responsible to analyze skin color tone, face geometry, or blending artefacts for reasoning while aural artifacts analyze the audio signals for reply or voice cloning attacks. In an exemplary embodiment, models to detect visual artifacts may be trained utilizing labeled datasets specifically having visual artifacts such as blurriness or blending inconsistencies in face regions. In an exemplary embodiment, exemplary outputs of the deployed models may be integrated, and reasoning may be performed to determine fake/manipulated media with explainability.

In an exemplary embodiment, the use of the Multimodal Deepfake Knowledge Graph 450 may provide a comprehensive interface that enables reasoning over multimodal inputs, improving the system's robustness and accuracy in detecting various forms of manipulation and explainability.

In an exemplary embodiment, use of the Multimodal Deepfake Knowledge Graph 450 may provide a comprehensive framework that may enable reasoning over multimodal inputs, improving the system's robustness and accuracy in detecting various forms of deepfakes (lipsync, faceswap, and other manipulated content). By correlating signals across different modalities, exemplary Multimodal Deepfake Knowledge Graph 450 may allow for a unified detection process, with insights derived from different detection models merged into a single, explainable output.

In some exemplary embodiments, the common sense 405, domain based 406 and logical reasoner 407 perform inter- and intra-modality reasoning based on different modalities and features sets. Finally, the interpretability module delivers a bag of explanations 404 in three different levels such as, textual 408, visual 409 and statistical 410 explanations.

FIG. 5 illustrates a block diagram 50 of a unimodal forgery detection model, consistent with one or more exemplary embodiment of the present disclosure. Specifically, FIG. 5 illustrates a mechanism of spectral and hand-crafted model that may use similarity matching, as an anomaly detection mechanism, to detect manipulated forgeries in authentic/real data. In an exemplary embodiment, block diagram 50 may be of a speech tampering detection (STD) descriptor construction, which may utilize novel approaches for detecting deepfakes. In an exemplary embodiment, exemplary STD descriptor based mechanism may apply advanced AI models, leveraging temporal and spectral analysis to detect partial deepfakes in audio data.

In an exemplary embodiment, exemplary approaches may detect audio deepfake detections based on various audio signal properties like the tempogram, chroma, and zero-crossing rate (ZCR) to analyze rhythmic and tonal consistency in audio signals.

In an exemplary embodiment, tempograms may capture temporal variations in an audio signal. In an exemplary embodiment, tempograms may be utilized to detect partial spoofs that fail to replicate the natural tempo of genuine audio. In some exemplary embodiments, distinguishing between natural and unnatural tempo is vital to the speech tampering detection (STD) descriptor based mechanism system 50, where tempo aids in identifying deepfake audio. Natural tempo reflects the smooth, rhythmic flow of genuine speech, while manipulated audio often shows irregularities like tempo shifts, time-stretching, or artificial pauses. The tempogram integrated with time localized rhythm stability (TLRS) captures these variations by analyzing changes in rhythm over time. In developed TLRS, rhythmic stability is quantified using a localized measure of tempo variations, penalizing anomalies in the periodicity structure to highlight unnatural rhythm discontinuities. Genuine audio presents consistent patterns, whereas deepfakes reveal abrupt changes and unnatural pauses. This difference helps train an exemplary model, enabling it to distinguish between authentic and manipulated audio by learning these key tempo inconsistencies by providing labeled audio.

In an exemplary embodiment, chroma representation informed by temporal coherence penalty (TCP) may be utilized to analyze pitch distributions. Along with TCP, chroma-based tonal analysis is augmented with a penalty function that adjusts temporal inconsistencies by modeling abrupt shifts in harmonic structures, thereby enhancing sensitivity to tonal based artifacts. In an exemplary embodiment, chroma representations may be utilized to detect tonal inconsistencies within the manipulated segments of the audio signal. In some exemplary embodiments, natural chroma reflects the harmonic structure and consistent pitch variations of genuine audio, aligning with the expected tonal patterns of human speech. By contrast, manipulated or deepfake audio exhibits unnatural chroma, characterized by irregular pitch shifts, mismatched harmonics, and distorted pitch distributions. These inconsistencies help the model differentiate real from spoof audio during training. By learning these variations, the model improves its ability to detect unnatural chroma in deepfakes by providing it labeled audio.

In an exemplary embodiment, zero-crossing rate (ZCR) modeled through frequency penalty (FDP) may be utilized to detect transition in audio signals. In an exemplary embodiment, ZCR is integrated with a dynamic penalty mechanism that captures unnatural fluctuations in the spectral envelope, thereby improving robustness to synthetic perturbations that may be utilized to pinpoint sudden transitions caused by manipulation or editing in the signal. In some exemplary embodiments, zero-crossing rate (ZCR) with FDP in the speech tampering detection (STD) identifies transitions in audio signals by measuring the rate at which the signal changes sign. In genuine audio, ZCR reflects the natural transitions between speech sounds, typically producing smooth and consistent rates. However, in manipulated or deepfake audio, ZCR often shows unnatural transitions, such as abrupt spikes or irregular fluctuations, resulting from editing or manipulation. These sudden changes in ZCR can indicate unnatural cuts, insertions, or modifications in the audio. During training, the model learns to distinguish between the steady transitions of real audio and the erratic ZCR patterns of tampered audio, improving its ability to detect deepfakes by providing labeled audio. In an exemplary embodiment, combined with chroma and tempo, ZCR strengthens the model's overall detection capabilities.

In an exemplary embodiment, utilizing STD descriptor based mechanism 50 may allow for detecting subtle changes at the boundaries between real and manipulated audio segments by analyzing rhythmic, tonal, and temporal inconsistencies. In an exemplary embodiment, utilizing these approaches allow for detecting partial deepfakes, which may not be utilizing conventional approaches.

In an exemplary embodiment, exemplary classification models utilize triplet loss training, where the model may be trained to differentiate between positive (authentic), negative (forged), and anchor (mixed) audio segments. In an exemplary embodiment, triplet loss method may encourage the model to measure similarities between an anchor audio segment and its corresponding positive or negative class, making it highly robust against subtle manipulations. In an exemplary embodiment, LTSM and triplet loss method's combined application in audio deepfake detection may be novel and their similarity-based allow for detection of deepfakes with greater accuracy compared to state-of-the-art (SOTA) systems, which generally rely on binary classification. In an exemplary embodiment, combination of designed STD descriptor, with MFCC, IMFCC, and self-supervised oriented deep representation, the LSTM-based DNN classifier, and triplet loss training provides a robust framework for detecting audio deepfakes. The STD descriptor-based mechanism integrated with deep representation captures both partial and complete manipulations in audio segments, also significantly enhancing the generalizability, enhancing the precision and reliability of deepfake detection.

In some exemplary embodiments, exemplary models 209 and 210, the spectral model may be used along with designed speech tampering detection (STD) and integrated deep representation as input to a shared DNN model.

These features include the tempogram with TLRS, zero crossing rates (ZCR) with FDP, and speech chroma with TCP and deep representation details. To further enhance the complementary sensitivity to spectral distortions induced by deepfake synthesis techniques the MFCC and IMFCC features are integrated with the STD descriptor vector. The Mel-Frequency Cepstral Coefficients (MFCC) capture the spectral characteristics of speech by mapping the power spectrum onto a Mel scale, which aligns more closely with human auditory perception, making it highly effective at detecting spectral distortions and speech pattern variations. Conversely, Inverse Mel-Frequency Cepstral Coefficients (IMFCC) operate in the inverse frequency domain, focusing on capturing low-frequency distortions and non-linear spectral manipulations by analyzing the signal's cepstral coefficients in reverse order, providing a more comprehensive view of audio manipulation. The tempogram with TLRS captures the variations in the unimodal data (e.g., audio data) and multimodal (e.g., video with manipulated audio segments) over time. Partially manipulated synthetic data (e.g., segmental forgeries in unimodal data) often struggles to perfectly replicate the natural fluctuations. Thus, it represents the temporal evolution of rhythmic content in unimodal and multimodal sensory data. The manipulated region in unimodal data (e.g., audio data) may introduce unnatural rhythmic patterns or inconsistencies in the temporal structure. While chroma with TCP features represent the energy and tonal distribution across different pitch classes, the ZCR with the FDP measures the rate at which the sensory signal changes its temporal characteristics. Sudden changes in ZCR, especially at transition points, could indicate potential manipulation points where the characteristics of the underlying unimodal data differ significantly.

The integration of self-supervised deep representation with STD descriptor vector may further enhance generalizability in partial deepfake detection. The STD descriptor vector along with MFCC, IMFCC and deep representation may further process with any exemplary classifier to further enhanced the distinction of features extracted for small segments in partial audio deepfake detection.

In some exemplary embodiments, this mechanism may be trained using three subsets of datasets-positive, negative, and anchor classes. In some exemplary embodiments, positive class may comprise authentic (bona fide) data samples, negative may contain forged data with distinct forgeries, and anchor class may consist of mixed class data used for training the model using triplet loss metrics. In some exemplary embodiments, model 50 may employ dual identical deep neural network (DNN) models, with shared weights and biases, to extract discriminative embeddings from the input data. In some exemplary embodiments, these embeddings may then be subsequently processed in a latent space using a metric learning approach, with similarity metrics, for effective discrimination between genuine and forged data. For instance, in the case of audio sensory data, model 50 takes an audio signal as input 500 and performs windowing and framing of the audio to extract sequences (S₁, S₂ . . . . Sn) represented below and in 502.

$$S\_i [ n ] = w [ n - iR ] * x [ n - iR ] \qquad ( 1 )$$

In some exemplary embodiments, extracted sequences may then be passed through identical DNN models 503 and 504, which could be any deep architecture such as ResNet-18 or a custom-built model, to obtain embeddings for each audio input. After obtaining the audio embeddings 505, they may be passed to the meta & metric learning block 506. In some exemplary embodiments, model 50's objective is to learn a task of similarity matching between the embeddings obtained from 505. Consequently, the output of this block is the metric-learned distance-based dimension 509 that is further used for classification 510. For metric learning 509, distance metrics, i.e., cosine and Euclidean similarities and for DNN models' loss triplet loss are used which are presented below:

$$d ( x , y ) = sqrt ( sum\_i ( x\_i - y\_i ) \hat{} 2 ) \qquad ( 2 )$$

$$sim ( x , y ) = ( x \cdot y ) / ( ‖ x ‖ * ‖ y ‖ ) \qquad ( 3 )$$

$$L = max ( 0 , d ( a , p ) - d ( a , n ) + margin ) \qquad ( 4 )$$

In some exemplary embodiments, exemplary embodiments provide forgery detection by utilizing a metric learning approach and dual identical DNN models to extract discriminative embeddings from the input data. The use of distance metrics and triplet loss further enhances the model's ability to distinguish between genuine and forged data.

FIG. 6A illustrates a block diagram for an exemplary neuro-symbolic approach for intermodality and intramodality forgery detection based on domain specific knowledge, consistent with one or more exemplary embodiments of the present disclosure. In some exemplary embodiments, FIG. 6A illustrates a temporal process 70, similar to any of the exemplary temporal processes 207 for inter- and intra-modality reasoning based on domain knowledge, consistent with one or more exemplary embodiments of the present disclosure. Exemplary process 70 may be utilized to detect inconsistencies within a single as well as between multiple modalities at a given timestamp using a neuro-symbolic approach. For instance, with temporal models 700, there may be features related to visual and aural modalities.

In some exemplary embodiments, exemplary features may be extracted. In some exemplary embodiments, the extracted features from both modalities are biometric signals such as visual emotions 706 and aural emotions 707. The first task is to convert these features into symbolic representations 701 over time and cab be formulated as:

$$VE = [ {f}_{i} ( E ) , {f}_{i + 1} ( E ) , {f}_{i + 2} ( E ) … {f}_{i + n} ( E ) ] \qquad ( 11 )$$

$$AE = [ {s}_{i} ( E ) , {s}_{i + 1} ( E ) , {s}_{i + 2} ( E ) … {s}_{i + n} ( E ) ] \qquad ( 12 )$$

where, VE and AE are the sets of biometric features (emotions) from visual and aural modality over time.

In some exemplary embodiments, these exemplary symbols may then be used to perform intra-modality reasoning for (visual) 702 and (aural) 703 modalities using psychological knowledge, based on probabilities of transition of emotions from one state to another as given in FIG. 6B (902). The rules defined for inconsistencies detection are given as:

$$t = mean ( KB ( {f}_{i} ( E ) \vert {s}_{i} ( E ) , : ) ) \qquad ( 13 )$$

$${VT}_{i} = \{ \begin{matrix}fake & if KB ( {f}_{i} ( E ) , {f}_{i + 1} ( E ) ) < t \\ real & otherwise\end{matrix} \qquad ( 14 )$$

$${AT}_{i} = \{ \begin{matrix}fake & if KB ( {s}_{i} ( E ) , {s}_{i + 1} ( E ) ) < t \\ real & otherwise\end{matrix} \qquad ( 15 )$$

where, VTi and ATi are the emotion transition status for visual and aural modalities at timestamp i, respectively.

Conventional for inter-modality inconsistencies detection are mostly based on final loss value to detect overall manipulation in multisensory data where it is not clear which modality is manipulated. In an exemplary embodiment, inter-modality reasoning 704 in exemplary embodiments may be based on well-known knowledge bases which can be used to interpret the decisions easily. For instance, arousal-valence dimensions may be formulated for seven basic emotions by distributing into 4 quadrants as shown in chart 904 of FIG. 6B. To determine variation in emotions of both modalities, the rule may be defined as:

$${IM}_{i} = \{ real if {f}_{i} ( E ) ∧ {s}_{i} ( E ) ∈ {Q}_{n} fake otherwise \qquad ( 16 )$$

where, IMᵢ is the resultant status of inter-modality reasoning for the visual and aural modality at time i. Qₙ is one of the quadrants where n ∈ [1,2,3,4] as shown FIG. 6B (904).

FIG. 6B illustrates a table 902 and a chart 904 associated with psychological knowledge, consistent with one or more exemplary embodiments of the present disclosure. In some exemplary embodiments, table 902 may be associated with emotions transition scores for intra-modality reasoning and chart 904 may contain emotional quadrants for inter-modality reasoning.

In some exemplary embodiments, multi-modal input signals may be classified into real (consistent) and manipulated (inconsistent) classes with visual and textual explanations 705. FIG. 6C illustrates visual graphs highlighting inconsistency detection for intermodality and intramodality. Specifically, FIG. 6C illustrates graphs of real samples and tempered samples. In some exemplary embodiments, exemplary graphs 1002 and 1004 in the first row may illustrate intramodality reasoning for real and tempered samples of visual modality respectively, graphs 1006 and 1008 in the middle row may represent real and tempered samples for aural modality respectively, while graphs 1010 and 1012 in the bottom row may show real and tempered samples in the intermodally reasoning for audiovisual modality. In some exemplary embodiments, dotted portion in each graph indicates unusual emotion transition or miss match between in the aural and visual modality.

FIG. 7A illustrates a block diagram of an exemplary lip synchronization approach, consistent with one or more exemplary embodiments of the present disclosure. In details, FIG. 7A illustrates an exemplary lip synchronization approach based on domain adaptation and canonical correlation analysis (CCA) to detect inconsistency between lip movements and spoken words.

In some exemplary embodiments, FIG. 7B illustrates samples of real and fake videos as synchronization problems, consistent with one or more exemplary embodiments of the present disclosure.

In some exemplary embodiments, FIG. 7B illustrates visual representation of a world leader saying words “Hi Everybody.” 1020 Real: both audio and visual signals are synchronized with the script as green color, 1022 FaceSwap: the visual signal are not matching the aural signal even in silent case as highlighted in red color, and 1024 LipSync: a clear miss match between visual and aural signal can be observed specially missing of the closing lips in the interval of ‘everybody’ indicated as red color.

In an exemplary embodiment, the approach illustrated in FIG. 7A may be similar to one of a spatiotemporal model 208 for a lip synchronization task. In an exemplary embodiment, a lipsync model, such as spatiotemporal model, may comprise of an exemplary multimodal deepfake detection framework, which may address the problem of deepfake detection by focusing on the synchronization between audio and video modalities. In an exemplary embodiment, an exemplary framework for lipsync may utilize a domain adoption strategy to generalize across multiple types of manipulations, datasets, and languages, offering a robust solution to the deepfake detection problem. In an exemplary embodiment, LipSync may leverage deep canonical correlation analysis (DCCA) 809 to perform synchronization-based analysis, making it uniquely suited for detecting deepfakes in multilingual and spatiotemporal data.

In an exemplary embodiment, LipSync may use a domain adoption strategy. In an exemplary embodiment, domain adoption strategy may refer to when features of a deep model trained for one task (speech recognition as source domain in exemplary embodiments) may be used for another task (deepfake detection as target domain in exemplary embodiments. Hence, spatiotemporal features may be utilized, extracted using well known speech recognition models (i.e., HuBERT and Wav2Vec2) from the last fully-connecting layers and may later be used for deepfake detection. In an exemplary embodiment, this may allow for this system to adapt to a wide range of manipulations, datasets, and multilingual inputs, making it highly generalizable for real-world applications. In an exemplary embodiment, utilizing this approach may allow for facilitating better handling of cross-lingual data and manipulations that are not represented in the training set.

In an exemplary embodiment, Lipsync model may apply embedding-level correlation analysis based on DCCA architecture to check whether the audio and visual modalities are synchronized or not. FIG. 7C shows an example of visual representation of the representations correlation between real and fake samples. In an exemplary embodiment, embedding-level correlation analysis may entail when the extracted features from audio 803 and visual 804 modalities are each sampled into standard dimensions (i.e., 40×896 in the exemplary scenario) and forwarded to the canonical correlation layer 808 that convert these features into aural 806 and visual 807 representations, ensuring accurate detection of deepfake manipulations across languages. In an exemplary embodiment, applying embedding-level correlation analysis may enable the framework to handle multilingual data, which often poses challenges for conventional deepfake detection approaches.

In an exemplary embodiment, exemplary LipSync models may have a customized architecture of Deep Canonical Correlation Analysis (DCCA) unit 809 to address the problem of spatiotemporal deepfake detection. In an exemplary embodiment, customized DCCA architecture may be composed of three fully connected layers of size 1024, 512, 256 and final layer of 128 for each aural 806 and visual 807 modality. A canonical correlation layer at the end combined both features after learning the correlation. This modified DCCA 809 architecture may be tailored specifically for deepfake detection by analyzing temporal synchronization between aural 806 and visual 807 streams. In an exemplary embodiment, this may ensure that the lip movements in the video are synchronized with the audio signals, making the framework highly effective at detecting mismatches that are indicative of deepfake content.

In an exemplary embodiment, an exemplary LipSync model may employ a unique representation learning strategy wherein the extracted raw features from the audio 803 and visual 804 streams of speech recognition domain may be converted into latent representations 806 and 807 after learning the correlation between each modality during the training DCCA 809 architecture. In an exemplary embodiment, latent representations may then be processed using the customized DCCA model to detect temporal and spatial inconsistencies across the modalities.

FIG. 7C illustrates scatter plots (charts) for real 1030, faceswap 1032, and lipsync 1034 representations in latent space. In an exemplary embodiment, these learned representations may have close correlation between audio and visual representation in case of real samples 1030 thereby forming a diagonal feature space. In contrast, the fake (lipsync 1034 and faceswap 1032) samples exhibit very low correlation thereby showing scattered distribution of the features.

In an exemplary embodiment, the concatenated aural 806 and visual 807 representations are then forwarded to a MLP based classifier 802 which may then classify the given video sample into two classes i.e., real or fake. This MLP classifier is trained in a conventional way.

In an exemplary embodiment, FIG. 8A depicts a block diagram of a generalized deepfake detection system 130 based on DBaG (deep identity, behavior, and geometry) descriptor, composed of facial behavior, geometry, and identity signature consistent with one or more exemplary embodiments of the present disclosure. In further detail, FIG. 8A illustrates one of spatial models 206 and handcrafted features 210 based on DBaG descriptor 906. In an exemplary embodiment, model 130 may utilize three types of features, behavioral features 903, geometric features 904 and deep identity features 905. In an exemplary embodiment, behavioral features 903 and geometric features 904 may be computed from facial landmarks 902. In an exemplary embodiment, images 901 are processed to compute landmarks 902 using a well-known library MediaPipe. The acquisition of blendshape features starts with the extraction of facial landmarks. An input face frame [224×224] from 901 is passed to a MobileNetV2 customized architecture to extract [1×478] facial landmarks. Next, to compute behavioral features 903, a comprehensive set of [1×52] blendshape behavioral features is extracted with an MLP-Mixer backbone. 146 out of 478 landmarks are used to derive blendshape behavioral features. Mediapipe is used to capture facial geometry 904, by calculating distances and the angles formed by various landmarks 902. This facial geometry provides a holistic representation of the structural aspects when discerning genuine facial attributes. The final feature vector for geometric features 904 is [1×36]. In order to capture deep identity features 905, a well performing quality adaptive face-recognition model, AdaFace, is deployed. It uses a ResNet backbone and applies a margin-based loss function to capture the deep features in low quality images. [114×114] is the input image to AdaFace and the final dimension of deep identity features may be [1×512]. After features computation, a DBaG descriptor may be composed by a novel combination of behavioral features 903, geometric features 904, and deep identity features 905. Further details regarding the DBaG descriptor 906 are provided in context of FIG. 8B.

FIG. 8B illustrates an exemplary scenario providing insight into functionality of the DBaG descriptor, consistent with one or more exemplary embodiments of the present disclosure. Representation of facial region 1400 for deep identity feature extraction, behavior features 1402 with localized face parts used to analyze facial behavior in real and fake context, and facial geometry 1404 feature to analyze various facial parts as geometrical features such as distance, area and angle.

In an exemplary embodiment, a lightweight and generalizable deep model may be applied for robust embeddings calculation for the binary classification of deepfakes 907. In an exemplary embodiment, a deep model may have 2D convolutions followed by residual blocks, 2D adaptive average pooling and fully connected layers. To capture the spatial and temporal details in the video frames, the DBaG feature descriptor vectors may be reshaped to 2D slices of 120 frames with an overlap of 60 frames. In an exemplary embodiment, final input vector for the model may be [120×1880]. In an exemplary embodiment, a triplet margin loss may be used for the model training, to generate the discriminative embeddings of real and fake feature vectors for better generalization on deepfakes detection. The training with triplet learning objective requires the dataset to be constructed to have an anchor, a positive and a negative vector for each training sample. A positive vector has the same label as the anchor while the negative vector has a different label. Once the training process is complete, embeddings for each sample in the training set are stored as reference set. These embeddings act as standard to compare the new (unseen) test samples, providing a fixed point of reference for label prediction. In an exemplary embodiment, the testing samples may be passed through the trained deep model, generating embeddings for each slice. To determine the label of a test embedding, its Euclidean distance from each reference embedding is computed providing a measure of similarity to the reference set. This step produces a set of distances d₁, d₂, d₃, . . . , dₙ that indicate how close the test embedding is to each reference sample. To assign a label to test embedding, the rank of all the distances (i.e., d₁, d₂, d₃, . . . , dₙ) in ascending order and identify the m smallest distances, representing the nearest neighbors of test embedding in the latent space. The label is then determined by a majority vote among the labels of these nearest neighbors. This majority voting process ensures that the final prediction considers multiple neighbors, providing robustness against outliers and minor variations in the latent space.

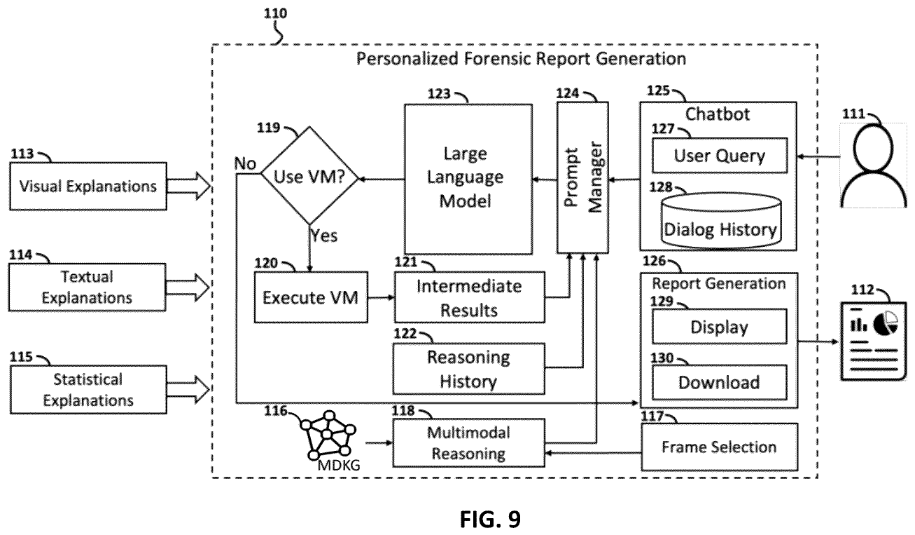

FIG. 9 illustrates various components of an exemplary report generation unit, consistent with one or more exemplary embodiments of the present disclosure. In some exemplary embodiments report generation unit may be structurally and functionally similar to an exemplary unit which may generate forensics report 04 and communicate with chatbot 05. In some exemplary embodiments, an input to report generation unit 110 may be visual explanations 113, textual explanations 114, and statistical explanations 115 of a given sample. In some exemplary embodiments, frame selection 117 may work based on statistical analysis of spatio-temporal or temporal, or spatial artifacts in a sensory input. Accordingly, exemplary frames may then then be prioritized based on the probabilities of spatio-temporal or temporal, or spatial artifacts and frames with high probabilities are selected as input to the multimodal reasoning unit 118. Each block in FIG. 9 may represent dependent executable instructions to generate customized forensic reports with multimodal data. In some exemplary embodiments, report generation unit 110 may further include Large Language Model (LLM) 123, prompt manager 124, chatbot 125, report generation 126, MDKG 116, frame selection 117, multimodal reasoning 118, visual model (VM) 120, intermediate results 121, and reasoning history 122. The multimodal reasoning module 119 takes input from MDKG 116 and frame selection module 117 and is responsible for generating multimodal reasoning into standard and human interpretable representation that may be used to create prompt in prompt manager 124. In an exemplary embodiment, output of a LLM largely depends on the relevance of the textual input also called prompt to perform a text generation task. In an exemplary embodiment, prompt manager 124 creates suitable prompts based on the input data for the LLM for report generation task. In some exemplary embodiments, with further detail to chatbox 125, chatbot 125 may be responsible for taking input from the end-user to make report generation task flexible, by adding human-in-the-loop for customizing report generation based on the user input. The chatbot 125 may store the conversation with the end user as dialog history 128. In some exemplary embodiments, prompt manager 124 may create a prompt for the LLM 123 based on user query 127, dialog history 128, reasoning history 122, intermediate results 121 (if the query is not new), and multimodal reasoning 118. Based on the provided prompt, LLM 123 generates a forensic report and invokes some visual models 120 if the prompt requires some visual figures attached to the report. In an exemplary embodiment, visual models 120 may be responsible for creating or modifying some visual figures based on the provided instructions. In an exemplary embodiment, reasoning history 122 may be maintained within one more databases and may be included in the prompt to make LLM learn better and improve with few-shot learning with time. If the LLM 123 generated result is final and doesn't require any visual model execution, all generated components are passed to the report generation module 126 to merge the components to generate the final forensic report. In some exemplary embodiments, generated report 112 may be displayed 129 to an exemplary user 111, and it may additionally be downloaded 130.

Accordingly, in some exemplary embodiments, chatbot 125 may also by act as a “virtual expert witness” that offers context-aware interaction with the users in natural language to divulge an ML decision making process of both exemplary data authenticity analysis and multimodal report generation units.

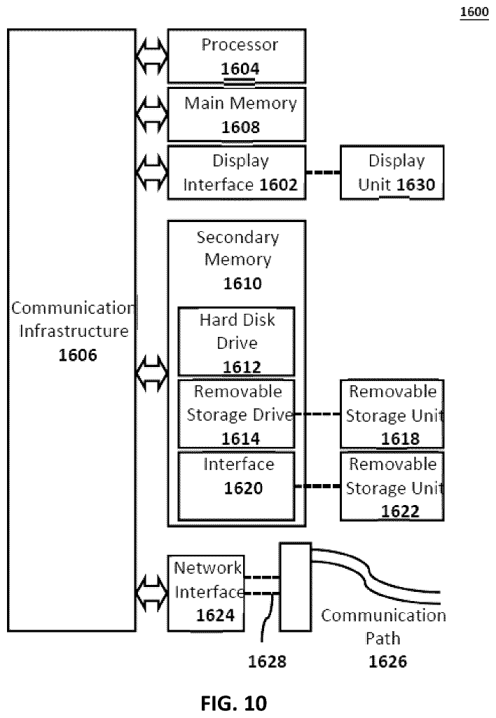

FIG. 10 illustrates an example computer system 1600 in which an embodiment, or portions thereof, may be implemented as computer-readable code, consistent with exemplary embodiments of the present disclosure. For example, code or instructions may be executed and implemented in computer system 1600 using hardware, software, firmware, tangible computer readable media having instructions stored thereon, or a combination thereof and may be implemented in one or more computer systems or other processing systems. Hardware, software, or any combination of such may embody any of the modules and components utilized with respect to the methods described in exemplary embodiments and the components and modules utilized.

If programmable logic is used, such logic may execute on a commercially available processing platform or a special purpose device. One of ordinary skill in the art may appreciate that an embodiment of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

An embodiment is described in terms of this example computer system 1600. After reviewing this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1604 may be a special purpose or a general-purpose processor device. As will be appreciated by persons skilled in the relevant art, processor device 304 may also be a single processor in a multi-core/multiprocessor system, such system operating alone, or in a cluster of computing devices operating in a cluster or server farm. Processor device 304 is connected to a communication infrastructure 306, for example, a bus, message queue, network, or multi-core message-passing scheme.

Computer system 1600 also includes a main memory 1608, for example, random access memory (RAM), and may also include a secondary memory 1610. Secondary memory 1610 may include, for example, a hard disk drive 1612, removable storage drive 1614. Removable storage drive 1614 may comprise a floppy disk drive, a magnetic tape drive, an optical disc drive, a flash memory, or the like. The removable storage drive 1614 reads from and/or writes to a removable storage unit 1618 in a well-known manner. Removable storage unit 1618 may comprise a floppy disk, magnetic tape, optical disc, etc., which is read by and written to by removable storage drive 1614. As will be appreciated by persons skilled in the relevant art, removable storage unit 1618 includes a computer usable storage medium having stored therein computer software and/or data.

In alternative implementations, secondary memory 1610 may include other similar means for allowing computer programs or other instructions to be loaded into computer system 1600. Such means may include, for example, a removable storage unit 1622 and an interface 1620. Examples of such means may include a program cartridge and cartridge interface (such as that found in video game devices), a removable memory chip (such as an EPROM, or PROM) and associated socket, and other removable storage units 1622 and interfaces 1620 which allow software and data to be transferred from the removable storage unit 1622 to computer system 1600.

Computer system 1600 may also include a communications interface 1624. Communications interface 1624 allows software and data to be transferred between computer system 1600 and external devices. Communications interface 1624 may include a modem, a network interface (such as an Ethernet card), a communications port, a PCMCIA slot and card, or the like. Software and data transferred via communications interface 1624 may be in the form of signals, which may be electronic, electromagnetic, optical, or other signals capable of being received by communications interface 1624. These signals may be provided to communications interface 1624 via a communications path 1626. Communications path 1626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1618, removable storage unit 1622, and a hard disk installed in hard disk drive 1612. Computer program medium and computer usable medium may also refer to memories, such as main memory 1608 and secondary memory 1610, which may be memory semiconductors (e.g. DRAMs, etc.).

Computer programs (also called computer control logic) are stored in main memory 1608 and/or secondary memory 1610. Computer programs may also be received via communications interface 1624. Such computer programs, when executed, enable computer system 1600 to implement the present invention as discussed herein. In particular, the computer programs, when executed, enable processor device 1604 to implement the disclosed processes, such as the operations related to each exemplary unit. Accordingly, such computer programs represent controllers of the computer system 1600. Where the invention is implemented using software, the software may be stored in a computer program product and loaded into computer system 1600 using removable storage drive 1614, interface 1620, and hard disk drive 1612, or communications interface 1624.

Embodiments also may be directed to computer program products comprising software stored on any computer useable medium. Such software, when executed in one or more data processing device, causes a data processing device(s) to operate as described herein. An embodiment may employ any computer useable or readable medium. Examples of computer useable mediums include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concepts disclosed herein. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

Throughout this specification and the claims which follow, unless the context requires otherwise, the word “comprise,” and variations such as “comprises” or “comprising,” will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “vertical,” “horizontal,” “up,” “down,” and “side-to-side” are used in a relative sense to the normal orientation of the apparatus.

What is claimed is:

1. A method for detecting manipulation in image, video, audio, or audiovisual media and generating a forensic report, comprising:
receiving, at one or more processors, sensory data from one or more sources of sensory data, the sensory data associated with the image, the video, the audio, or the audiovisual media, and the sensory data comprising multimodal or unimodal sensory data;
preprocessing the sensory data, utilizing the one or more processors, by applying normalization to the sensory data;
extracting features, utilizing artificial intelligence and the one or more processors, from the preprocessed sensory data, utilizing artificial intelligence or the one or more processors, the extracted features comprising spatial, temporal, spatiotemporal, and spectral features, the extracted features comprising deep features and handcrafted features, wherein the deep features comprise features extracted using a deep neural network, and wherein the handcrafted features are extracted utilizing pattern calculation operations;
generating correlated features, utilizing the artificial intelligence, by applying intrafeature reasoning when the extracted features are associated with the single modality sensory data and applying both the intrafeature reasoning and interfeature reasoning when the extracted features are associated with the multimodal sensory data,
wherein applying the intrafeature reasoning comprises determining a relationship between consecutive frames of a respective single modality of the single modality sensory data or the multimodal sensory data by utilizing a correlation between the consecutive frames, and
wherein applying interfeature reasoning comprises determining a relationship between two associated frames of the multimodal sensory data by utilizing correlation between the two associated frames, the two associated frames each from different respective modalities in the multimodal sensory data;
generating predictions, utilizing the artificial intelligence, by applying both anomaly detection and classification in parallel to the correlated features, wherein generating the predictions by applying the anomaly detection comprises generating one or more predictions consisting of probabilities of the sensory data being real data or fake data by applying metric based meta learning on the correlated features, and
wherein generating the predictions, utilizing the artificial intelligence, by applying the classification, comprises generating additional one or more predictions consisting of probabilities of the sensory data being real data or fake data, where the additional one or more prediction indicating probabilities of the sensory data being fake data comprising probabilities associated with one more predefined classes, each of the predefined classes indicative of a respective forgery type;
the respective forgery type comprising one or more of faceswap, face-enhancement, attribute manipulation, lipysnc, expression swap, neural texture, talking face generation, replay attack, voice cloning attack, or any combination two or more forgeries;
training a rule generation model iteratively, utilizing the artificial intelligence, based on the correlated features and dataset generated predictions from detection models, wherein a labeled training dataset comprises multimodal and unimodal sensory data associated with one or more of image dataset, video dataset, audio dataset, or audiovisual dataset, wherein the correlated features and dataset generated predictions generated based on the labeled training data set, wherein portions of the image dataset, the video dataset, the audio dataset, or the audiovisual dataset are labeled as real or fake, wherein the detection models comprise supervised models, semi-supervised models, and unsupervised models, the training of the rule generation model further comprising:
inputting the dataset extracted features and dataset generated predictions to the rule generation model, the rule generation model comprising a Rule-based Representation Learner (RRL) and a Context-Aware Reasoning Learner (CARL),
generating rules by learning relationships between the dataset extracted features across unimodal and multimodal sensory data and validating the generated rules utilizing by matching them with ground-truth labels of the multimodal and unimodal sensory data, iteratively updating the rules support scores by training;
categorizing the generated rules into Type 1 rule or Type 2 rule based on a support score associated with each respective generated rule of the generated rules, wherein the Type 1 rule comprises support scores greater than a threshold and the Type 2 rule comprises a support score less than the threshold,
wherein in instances of the Type 1 rule, integrating the Type 1 rule and a corresponding enhanced Type 1 rule into a finalized generation model of the generation model, the enhanced Type 1 rule generated, utilizing multimodal deepfake large language model (MD-LLM), based on the Type 1 rule, the MD-LLM comprising fine-tuning a multimodal large langue model using query and response pairs along with input multimodal sensory data, the query and response pairs is generated utilizing Type 1 rules, wherein the query and response generation involve template based conversion of Type 1 rules into the query and response, wherein templates are designed based on structured queries and response associated with forgery types and detection models;
wherein in instances of the Type 2 rule, inputting the Type 2 rule into Prioritization Model Indices (PMI) for identification of low performing models (Mₓ) and associated samples (S_{y}) utilizing rules ranking and model involvement mechanism, the PMI comprising:
ranking the Type 2 rules into different levels based on respective support score thresholds and the involvement of contributing models to the rules;
generating a refined dataset for next iteration utilizing signature amplification, wherein the signature amplification comprises a prototype database and a similarity measurement, wherein the prototype database comprises multimodal samples taken from diverse datasets belonging to each class of the training dataset, and similarity measurement is based on Euclidean distance or cosine distance:
forming augmented samples (S′y) comprising a set of newly selected prototypes and misclassified sample together by refining misclassified samples in the samples (Sy) by finding a first amount of prototypes that capture one or more characteristics of a respected class of the samples (Sy):
wherein, training the rule generation model iteratively occurs until one of the following criteria is met:
if a first amount of consecutive integrations result in no contribution to increasing the support score for the specified rules;
if the overall performance of the rule generation model on a certain amplified dataset does not lead to improved accuracy.
generating, utilizing the artificial intelligence, multimodal deepfake knowledge graph (MDKG) based on the correlated features and the predictions, wherein generating the MDKG comprises applying a rule generation model based on the correlated features and the predictions, the rule generation model comprising a data driven knowledge model and expert knowledge model, the data driven knowledge model comprising a Rule Representation Learning model (RRL) and Context-Aware Representation Learning model (CARL), and a Multimodal Deepfake Large Language model, the expert model generated based on domain expert knowledge, wherein the MDKG comprises a plurality of nodes and a plurality of relationships, wherein each of the plurality of nodes respectively indicating one of a respective modality, a respective forgery detection model, a respective forgery type, and a respective artifact, wherein each of the relationships connecting two respective nodes of the plurality of nodes based on predefined ontology model, a relation in predefined ontology could be hierarchal or non-hierarchical; generating, utilizing the artificial intelligence, a forensic report based on the correlated features and the MDKG, comprising
generating a bag of explanations by applying one or more unimodal and multimodal reasoning models utilizing the correlated features and rules from MDKG, wherein the unimodal and multimodal reasoning models comprise a common sense reasoning model, logical reasoning model, and domain based reasoning model, wherein:
analyzing inconsistencies in environmental cues in the correlated features comprises lighting conditions and shadows directions utilizing commonsense reasoning model;
analyzing inconsistencies in biological signal patterns in correlated features comprises lip-speech synchronization, gaze stability, and speech consistency utilizing the logical reasoning model; and
analyzing manipulation signatures in the correlated features comprises blending artifacts and voice cloning anomalies utilizing the domain based reasoning model;
storing reasoning output in the bag of explanations as database, wherein the bag of explanations comprise one or more of textual data, visual data and statistical data, wherein the textual data explains relationships of the nodes of the MDKG, wherein the visual data localizes one or more portions in unimodal and multimodal sensory data, and plotting GradCAM maps over the unimodal and multimodal sensory data, and the statistical data comprising data used to plot one or more scattered plots, graphs, or bar charts to verify the reasoning outputs;
generating a personalized forensic report with human in loop customization utilizing a chatbot and the generated forensic report, wherein the chatbot offers context-aware interaction with users in natural language, the chatbot comprising a large language model (LLM), dialog history, prompt manager and reasoning history, the generating the personalized forensic report further comprising;
inputting a user query to the chatbot to facilitate report customization by utilizing stored dialog history;
utilizing a prompt manager to generate a prompt based on the user query, the reasoning history, intermediate results, and multimodal reasoning for the large language model (LLM), wherein the LLM invokes visual models in case visual explanations are required;
creating or modifying visual figures based on the query from the user utilizing one or more visual models; and
updating the prompt based on reasoning history, the reasoning history comprising history of logical reasoning, commonsense reasoning, and domain based reasoning; and
displaying or allowing downloading of the personalized forensic report.

2. The method of claim 1, wherein applying the normalization to the sensory data further comprises one or more of:
resizing image or video data into a standard size;
sampling the audio into standard size or frequencies range; and
determining presence of a face region in a respective video.

3. The method of claim 1, wherein applying metric based meta learning comprising of one or more of:
constructing speech tampering detection descriptor (STD) by extracting temporal representations, spectral representation, and rhythmic representations from the audio signal, wherein constructing the speech tampering detection descriptor further comprising:
extracting temporal representations utilizing chroma features with temporal coherence penalty (TCP), wherein temporal coherence penalty enhances chroma based tonal temporal inconsistencies by modeling abrupt shifts in harmonic structures;
extracting spectral representation utilizing Zero-Crossing Rate (ZCR) with frequency deviation penalty (FDP), wherein frequency deviation penalty captures unnatural fluctuations in a spectral envelope; and
extracting rhythmic representations utilizing Tempogram with time-localized rhythm stability (TLRS), wherein time-localized rhythm stability quantifies localized tempo variations, penalizing highlight unnatural rhythm discontinuities;
generating an enhanced feature vector by integrating STD descriptor with Mel-Frequency Cepstral Coefficients (MFCC) and Inverse Mel-Frequency Cepstral Coefficients (IMFCC);
reshaping the enhanced feature vector to 1D representations utilizing long short term memory (LSTM)-based deep neural network (DNN);
training a metric-based meta-learning model based on the reshaped feature vector, wherein training the metric-based meta-learning model comprises triplet loss training to classify input audio based on similarity of anchor, positive, and negative classes of the embeddings, wherein the training enables the metric-based meta-learning model to assess similarity between authentic and manipulated speech samples at both segment and utterance levels.

4. The method of claim 1, wherein:
the extracting the features further comprises:
extracting aural and visual emotion features from the multimodal sensory data, utilizing the artificial intelligence, wherein the aural and visual emotion features comprise aural and visual emotion deep features;
classifying an emotion class, utilizing the artificial intelligence, based on the extracted aural and visual emotion features, wherein the emotion class comprises one of normal, sad, happy, angry, disgust, fear, and surprise;
determining emotion inconsistency of the classified emotion class, utilizing the artificial intelligence, based on applying intramodal reasoning and intermodal reasoning based on the classified emotion class and external knowledge, wherein the external knowledge comprises:
in instances of application of intramodal reasoning, probabilities for emotions transition from one emotion class to another in the form of matrix for all pre-defined emotion classes, wherein the probability acquired from at least a human expert;
in instances of application of intermodal reasoning, arousal-valence dimensions of seven emotion classes illustrated into one of four quadrants acquired from psychology domain for intermodal reasoning, wherein the arousal-valence dimensions acquired from at least the human expert.

5. The method of claim 4, in the instances of application of the intermodal reasoning further comprising:
determining the multimodal sensory data is real when aural and visual emotion are in a same quadrant; and
determining the multimodal sensory data is fake when aural and visual emotion are not in the same quadrant.

6. The method of claim 1, wherein, extracting the features further comprises:
extracting speech recognition features from multisensory data, wherein the speech recognition features comprising audio features and video features, wherein the audio features are extracted utilizing Wav2vec model, and wherein the visual features are extracted utilizing AV-HuBERT model;
generating learned representations by converting the extracted speech recognition features using deep canonical correlation analysis (DCCA) model, comprising of;
training the DCCA model based on the extracted speech features to learn correlation between audio features specific to spoken words and video features specific to lips movement to enable synchronization assessment across multilingual data utilizing backpropagation;
determining inconsistencies in the learned representations as synchronization problem by utilizing a classification layer comprising softmax function, wherein the classification layer addresses deepfake detection in the multimodal sensory data.

7. The method of claim 1, wherein, extracting the features further comprises:
construct a DBaG descriptor by extracting deep identity (D), behavioral (B), and geometric (G) features from the unimodal sensory data, wherein the DBaG descriptor is a unified feature vector comprising:
deep Identity features extracted utilizing a face recognition model;
behavioral features extracted utilizing a facial blendshape model; and
geometric features extracted utilizing a handcrafted feature extractor;
reshaping the DBaG descriptor vector into 2D slices;
convert the DBaG descriptor vector into 1D feature vector by inputting the reshaped DBaG descriptor vector into a deep neural network, the deep neural network comprising of 2D convolutions, residual blocks, adaptive pooling, and fully connected layers; and
training a metric based meta learning model based on the 1D DBaG feature vector, wherein training the metric based meta learning model comprising triplet loss training to classify input video based on similarity of anchor, positive, and negative classes of the embeddings, wherein the training enables the metric based meta learning model to assess similarity between authentic and manipulated samples.
